(19) United States
(12) Patent Application Publication
(10) Pub. No.: US 2011/0196864 A1
(43) Pub. Date: Aug. 11, 2011

(54) APPARATUSES, METHODS AND SYSTEMS FOR A VISUAL QUERY BUILDER

(76) Inventors: Steve Mason, San Francisco, CA (US); Ammon Haggerty, Oakland, CA (US); Michael Harville, Palo Alto, CA (US); Patrick Connolly, San Francisco, CA (US)

(21) Appl. No.: 12/875,979

(22) Filed: Sep. 3, 2010

Related U.S. Application Data
(63) Continuation-in-part of application No. 12/553,966, filed on Sep. 3, 2009.
Application No. 12/553,966 is a continuation-in-part of application No. 12/553,961, filed on Sep. 3, 2009.
Application No. 12/553,961 is a continuation-in-part of application No. 12/553,959, filed on Sep. 3, 2009.
Application No. 12/553,959 is a continuation-in-part of application No. 12/553,962, filed on Sep. 3, 2009.

(51) Int. Cl. G06F 17/30

(52) U.S. Cl. 707/728; 707/E17.014

(57) ABSTRACT

The APPARATUSES, METHODS AND SYSTEMS FOR A VISUAL QUERY BUILDER (“VQB”) take user gesture inputs on displayed objects, and transform them via VQB components into search results display objects arranged by search relevance in proximity to the displayed objects. In one embodiment, the VQB obtains an object-manipulating gesture input, and correlates the object-manipulating gesture input to a display object. The VQB then classifies the object-manipulating gesture input as a specified type of search request. The VQB generates a search query according to the specified type of search request using metadata associated with the display object, and provides the search query to search engine(s) and/or database(s). The VQB obtains, in response to providing the search query, search result display objects and associated search result display object relevance values. The VQB displays the search result display objects arranged in proximity to the display object such that search result display objects are arranged according to their associated search result display object relevance values.

### PRIORITY CLAIM

This application is a continuation-in-part of, and hereby claims priority under 35 USC §§119, 120, 365 and 371 to the following applications: U.S. application Ser. No. 12/553,966 filed Sep. 3, 2009, entitled “Large Scale Multi-User, Multi-Touch System”; U.S. application Ser. No. 12/553,961 filed Sep. 3, 2009, entitled “Calibration for a Large Scale Multi-User, Multi-Touch System”; U.S. application Ser. No. 12/553,959 filed Sep. 3, 2009, entitled “Spatial Apportioning of Audio in a Large Scale Multi-User, Multi-Touch System”; and U.S. application Ser. No. 12/553,962 filed Sep. 3, 2009, entitled “User Interface for a Large Scale Multi-User, Multi-Touch System. The entire contents of the aforementioned application are herein expressly incorporated by reference.

### FIELD

The present invention is directed generally to apparatuses, methods, and systems for search engine interfaces, and more particularly, to APPARATUSES, METHODS AND SYSTEMS FOR A VISUAL QUERY BUILDER.

### BACKGROUND

Users manually enter keywords into public search engines such as Google or local databases such as Microsoft Access to obtain search results. Users refine their search queries by iteratively modifying the choice of keywords, either accepting automated modification suggestions from the search engine or local database, or entering additional or alternative keywords into these information retrieval sources. Search engines typically accept textual entry for retrieval of both web pages and media such as images and video.

### SUMMARY

The APPARATUSES, METHODS AND SYSTEMS FOR A VISUAL QUERY BUILDER (“VQB”) take user gesture inputs on displayed objects, and transform them via VQB components into search results display objects arranged by search relevance in proximity to the displayed objects.

In one embodiment, the VQB obtains an object-manipulating gesture input, and correlates the object-manipulating gesture input to a display object. The VQB then classifies the object-manipulating gesture input as a specified type of search request. The VQB generates a search query according to the specified type of search request using metadata associated with the display object, and provides the search query to search engine(s) and/or database(s). The VQB obtains, in response to providing the search query, search result display objects and associated search result display object relevance values. The VQB displays the search result display objects arranged in proximity to the display object such that search result display objects are arranged according to their associated search result display object relevance values.

### BRIEF DESCRIPTION OF THE DRAWINGS

The accompanying appendices and/or drawings illustrate various non-limiting, example, inventive aspects in accordance with the present disclosure:

FIGS. 1A-K are of block diagrams illustrating various exemplary aspects of visual query building in some embodiments of the VQB;

FIG. 2 is of a data flow diagram illustrating exemplary aspects of implementing aggregated multi-search engine processing of visually built queries in some embodiments of the VQB;

FIG. 3 is of a block diagram illustrating various exemplary visual query builder components in some embodiments of the VQB;

FIGS. 4A-B are of logic flow diagrams illustrating exemplary aspects of visually building queries to submit for aggregated multi-search engine processing in some embodiments of the VQB, e.g., a Visual Query Builder (“VQB”) component;

FIG. 5 is of a logic flow diagram illustrating exemplary aspects of correlating complex multi-dimensional, multi-user input to visual display objects in some embodiments of the VQB, e.g., an Input-Display Object Correlation (“IDOC”) component;

FIG. 6 is of a logic flow diagram illustrating exemplary aspects of classifying into gestures the multi-dimensional, multi-user inputs correlated to visual display objects in some embodiments of the VQB, e.g., a User Gesture Classification (“UGC”) component;

FIG. 7 is of a logic flow diagram illustrating exemplary aspects of triggering generation and submission of user input gesture derived queries in some embodiments of the VQB, e.g., a Search Trigger Generation (“STG”) component; and

FIG. 8 is of a block diagram illustrating embodiments of the VQB controller.

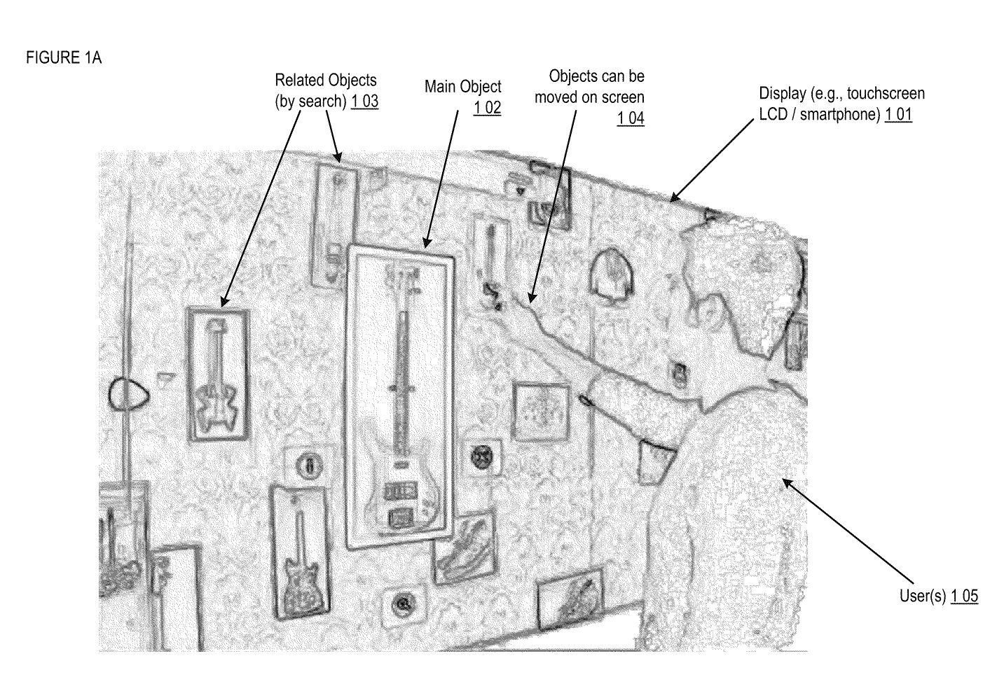

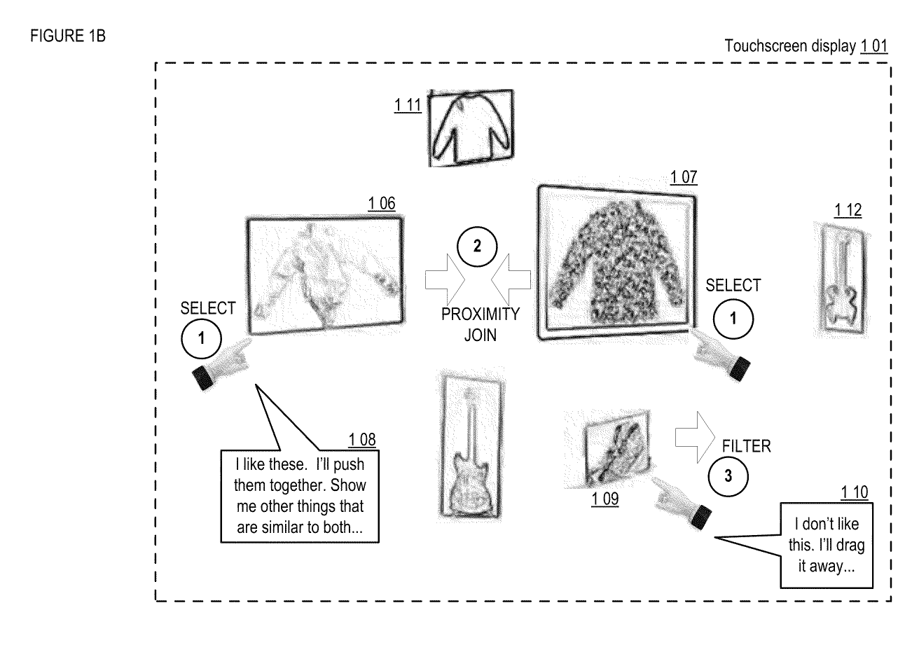

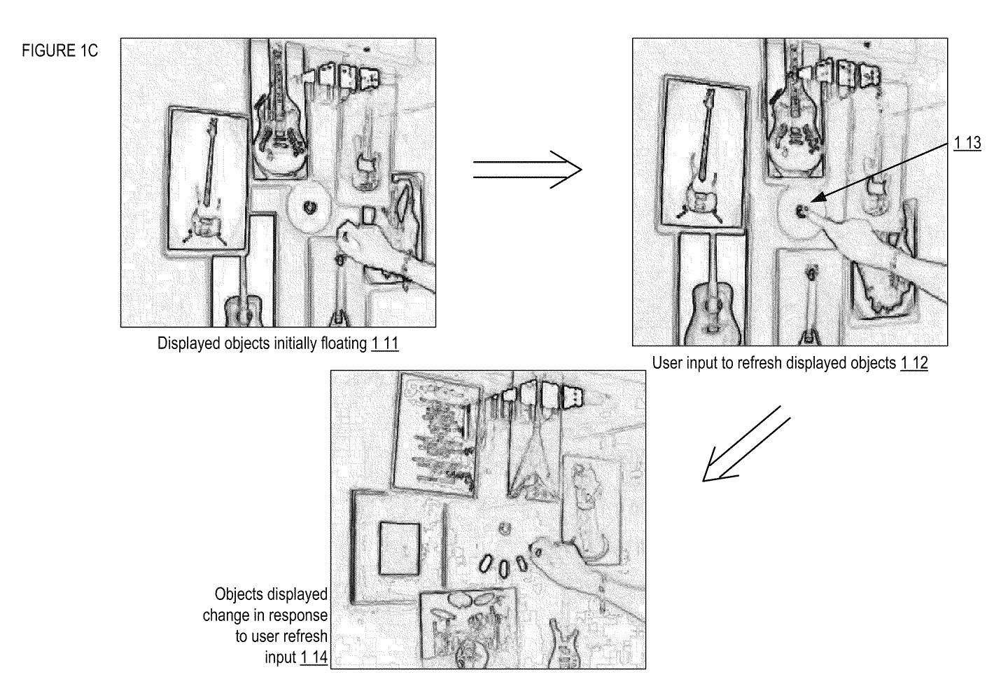

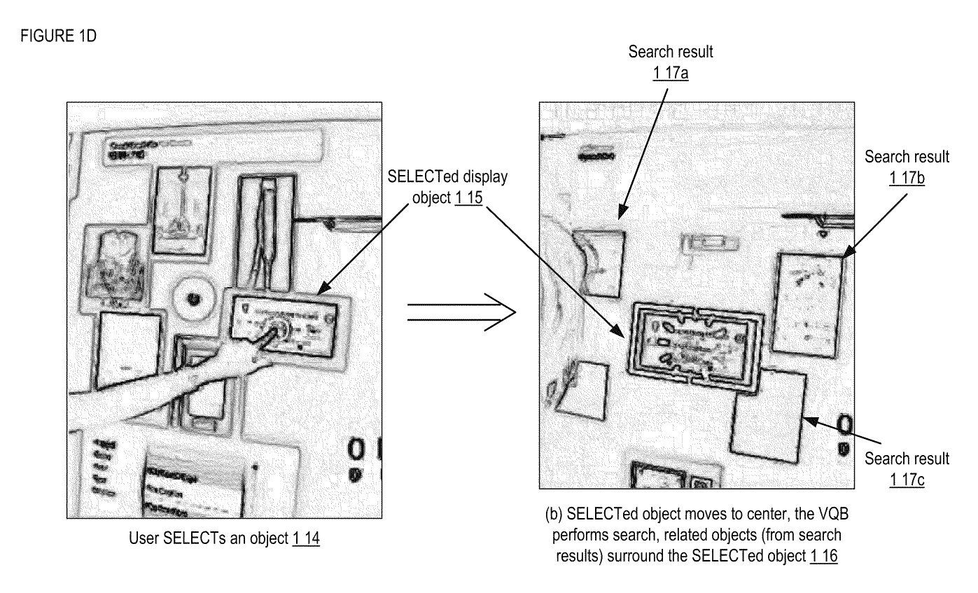

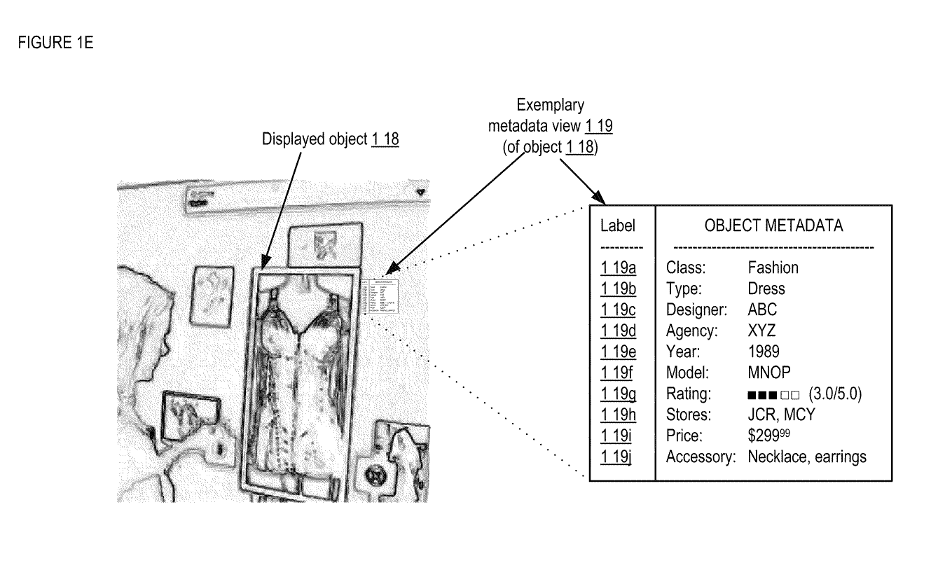

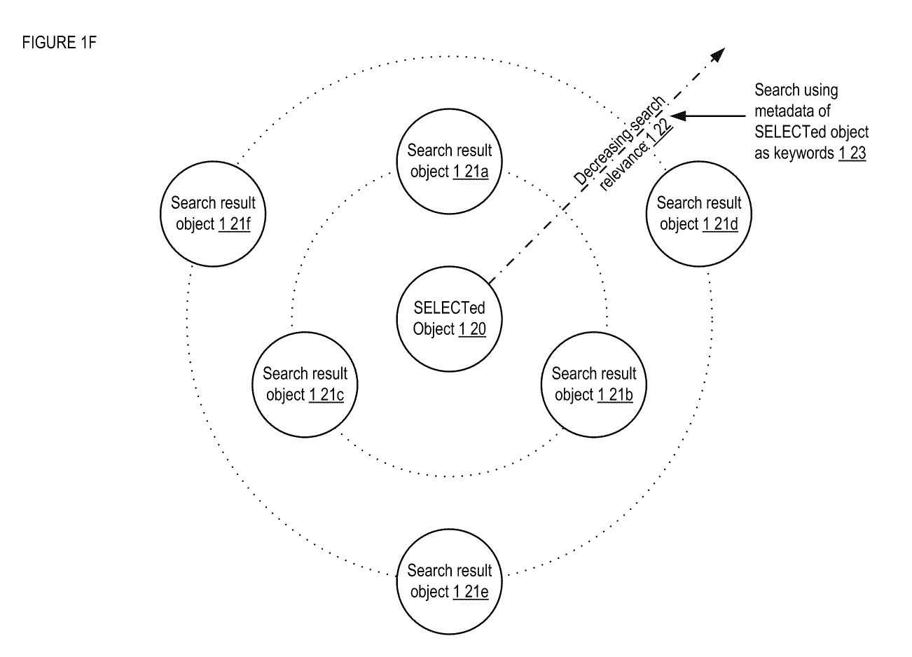

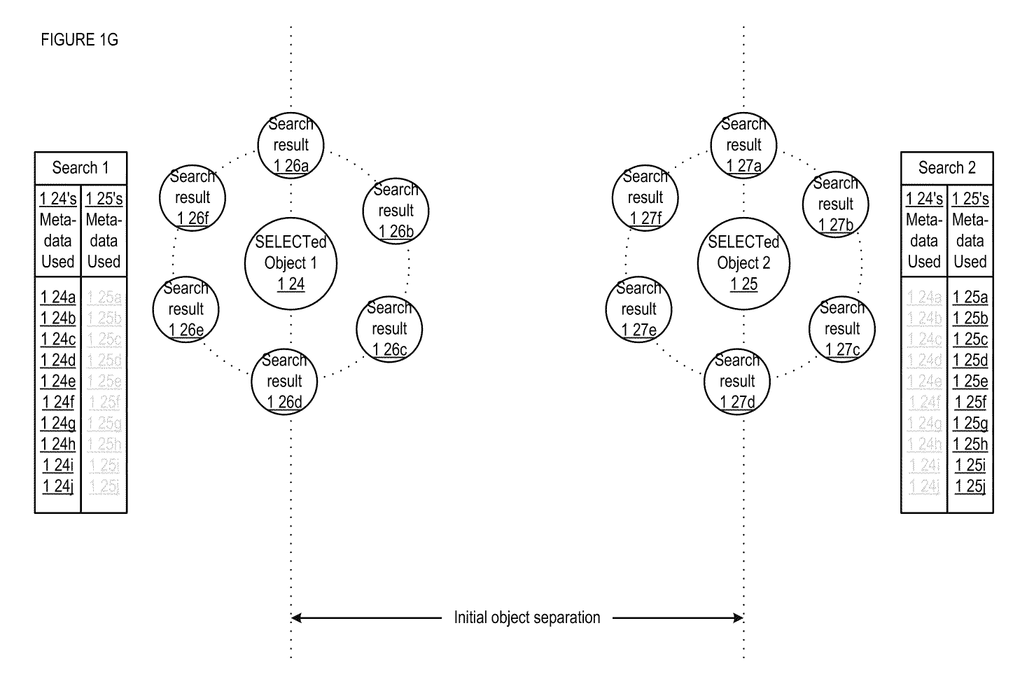

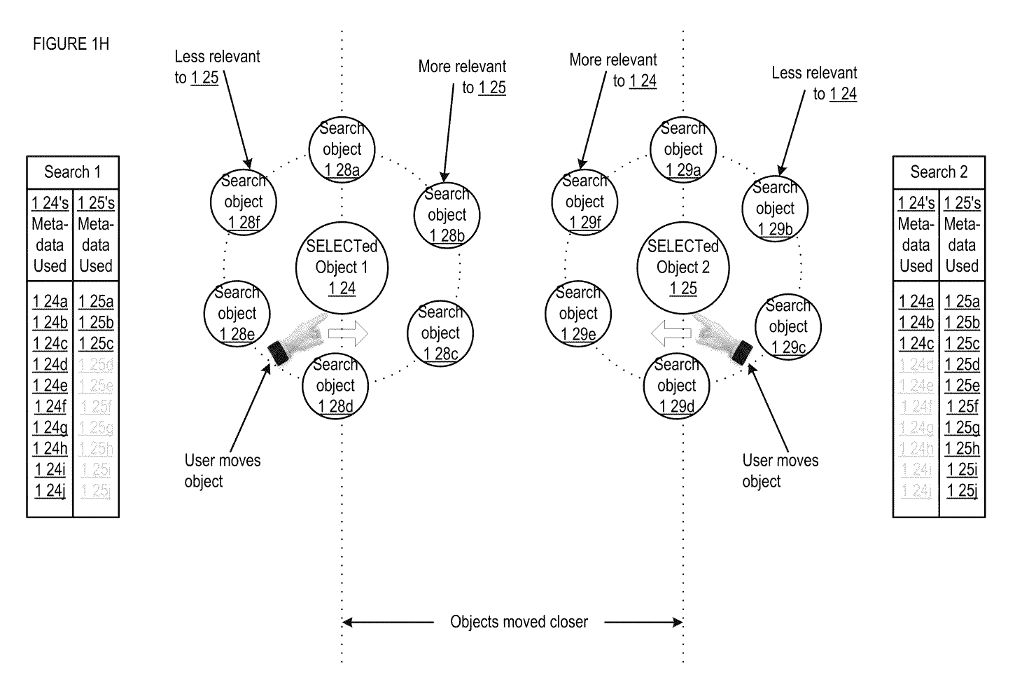

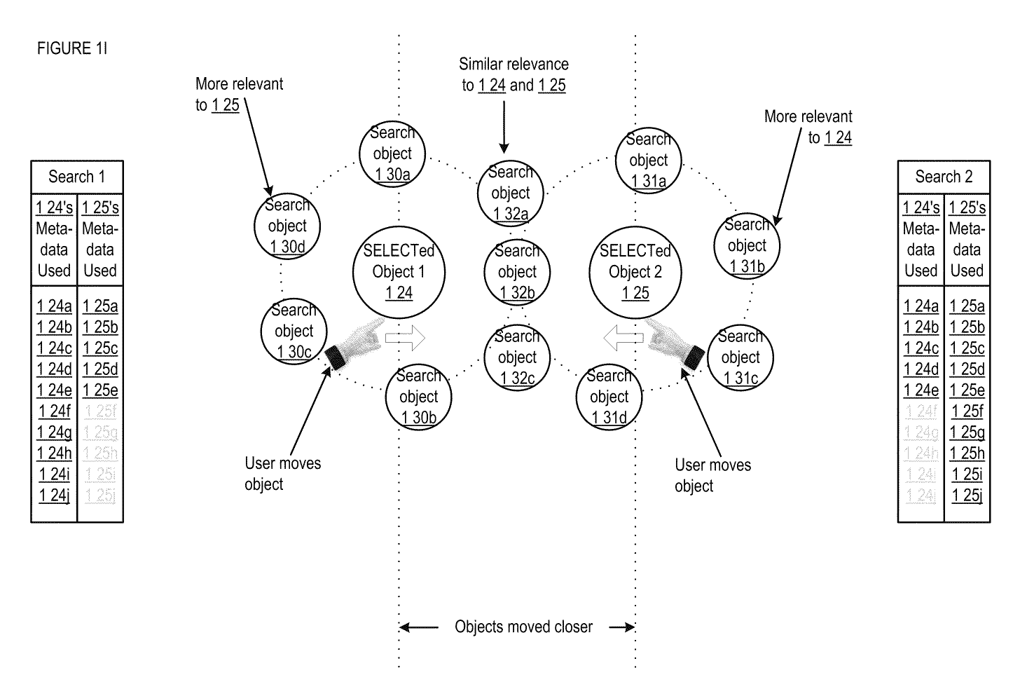

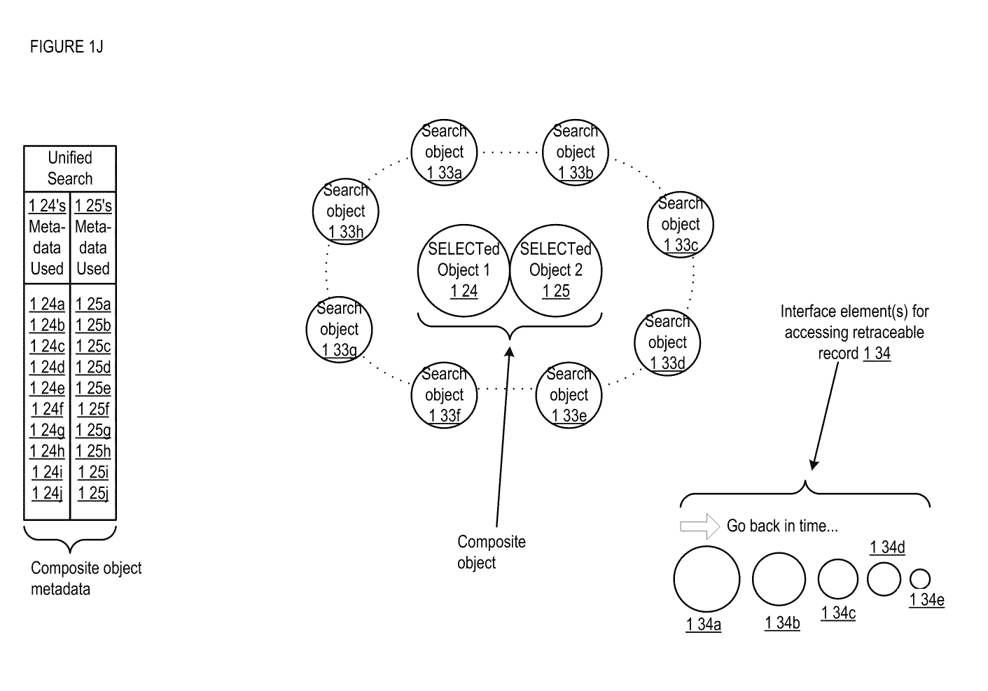

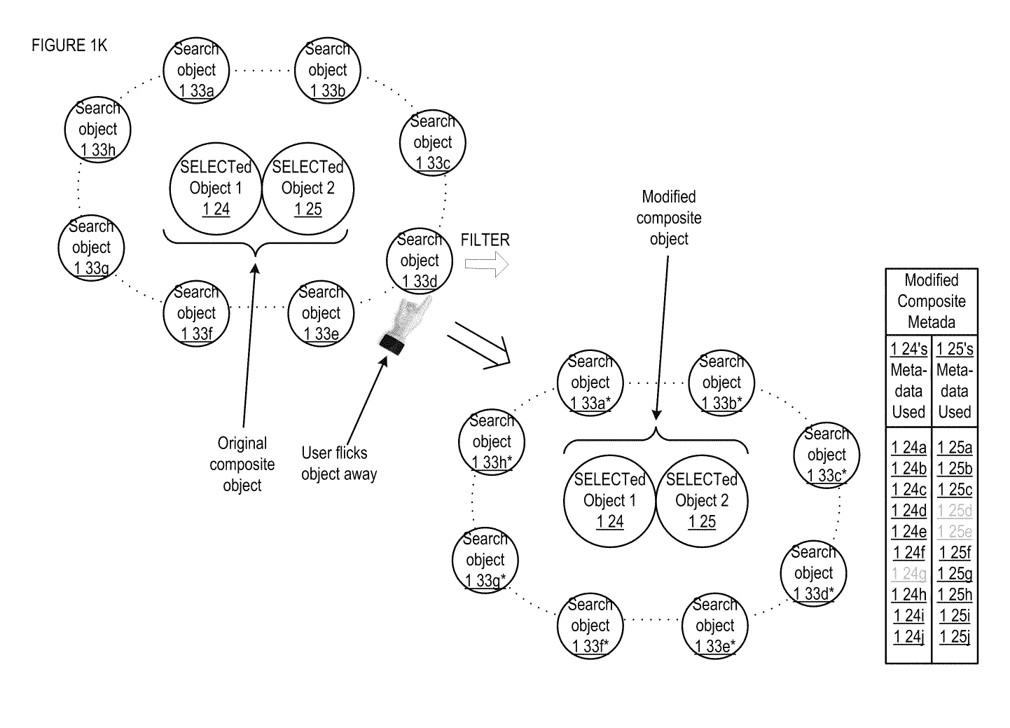

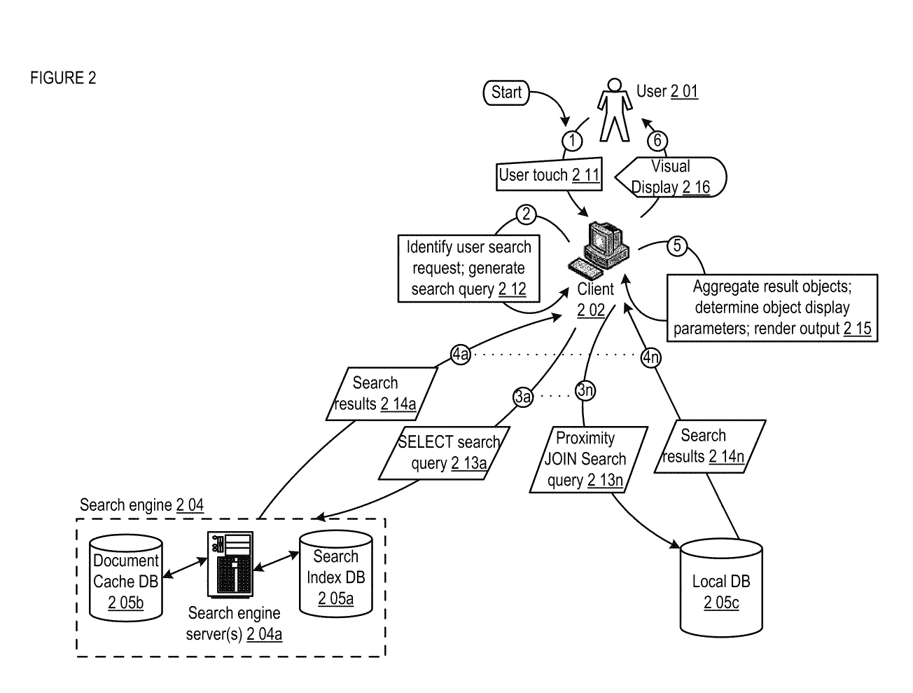

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Visual Query Builder (VQB)

FIGS. 1A-K are of block diagrams illustrating various exemplary aspects of visual query building in some embodiments of the VQB. In some implementations, a user 105 may be utilizing a device 101 including a visual display unit and a user interface, e.g., a trackpad, (3D; stereoscopic, time-of-flight 3D, etc.) camera-recognition (e.g., motion, body, hand, limb, facial expression and/or gesture recognition), touchscreen interface etc., for the user to provide gesture input manipulating objects displayed on the visual display unit. For example, the user may be utilizing a touchscreen smartphone. As another example, the user may be utilizing a large-screen multi-user touchscreen Liquid Crystal Display (“LCD”) display unit, such as described in the following patent applications: U.S. application Ser. No. 12/553,966 filed Sep. 3, 2009, entitled “Large Scale Multi-User, Multi-Touch System”; U.S. application Ser. No. 12/553,961 filed Sep. 3, 2009, entitled “Calibration for a Large Scale Multi-User, Multi-Touch System”; U.S. application Ser. No. 12/553,959 filed Sep. 3, 2009, entitled “Spatial Apportioning of Audio in a Large Scale Multi-User, Multi-Touch System”; and U.S. application Ser. No. 12/553,962 filed Sep. 3, 2009, entitled “User Interface for a Large Scale Multi-User, Multi-Touch System.” The entire contents of the aforementioned applications are herein expressly incorporated by reference. The display unit may display various display objects including, but not limited to: web pages, text, graphical images, movies, video, and/or the like. A user may be able to manipulate 104 the objects displayed via the user gesture input interface. For example, the user may be able to, e.g., select, de-select, move, scale, rotate, flick, filter and join objects via applying gestures and simulated physics models (e.g., open source Bullet Physics engine, NVIDIA PhysX, etc.) to the objects using the user gesture input interface. In some implementations, the user may have selected an object, e.g., 102, as being an object of interest to the user. In such implementations, this in turn may result in the VQB issuing a database SELECT command. For example, the VQB may perform a search of various databases and via various search engines to find information related to the object selected by the user. Each object may have an associated data structure having keywords, metadata and data (e.g., audio, images, video, text, hyperlinks, multimedia, etc.) related thereto. In some implementations, the VQB may obtain the search result information, and convert the information (e.g., news clippings, text, blogs, pictures, video, etc.) obtained via the search into display objects themselves, and may display these search result display objects 103 in the vicinity of the display object selected by the user. For example, the VQB may arrange the search related objects 103 in a circle around the user-selected display object 102.

In some implementations, the user may control the characteristics of the search related objects displayed on the visual display unit. For example, with reference to FIG. 1B, the user may like the attributes of two separate objects displayed on the visual display unit, e.g., display object 106 and display object 107. The user may wish to view, e.g. 108, search related display objects similar to the display objects 106 and 107. In such implementations, the user may select the display objects 106 and 107, e.g., by applying pressure on the touchscreen on top of the display objects 106 and 107. The display objects 106 and 107 may be selected upon the user providing the object-selecting gesture (in this example, applying pressure to the touchscreen over the display objects). The user may then move the two objects towards each other by, e.g., providing a pressing and dragging gesture to the two display objects 106 and 107 towards one another. In some implementations, the VQB may implement one or more proximity JOIN search queries based on the two display objects, upon identifying that the user has selected the two display objects 106 and 107, and is dragging them towards each other. For example, the VQB may initiate one proximity JOIN search query for display object 106 and another proximity JOIN search query for display object 107, upon identifying that the user has selected the two display objects. The VQB may, to perform the initiated searches, obtain metadata related to the display objects 106 and 107, e.g., from the results of a prior search that resulted in display objects 106 and 107 being displayed on the visual display unit. The VQB may determine proximity (separation) of the display objects 106 and 107 to each other upon identifying that the user is dragging the two display objects 106 and 107 towards each other. Based on the proximity of the display objects 106 and 107, the VQB may determine, e.g., how much of the metadata for display object 107 should be utilized in the search for display objects that will surround display object 106. Similarly, the VQB may determine how much of the metadata for display object 106 should be utilized in the search for display objects that will surround display object 107. In some implementations, such cross-over of metadata from one display object into the search query for another display object may increase as the two objects are moved closer together by the user.

In some implementations, the user may not like, e.g. 110, the attributes of a display object, e.g., 109, being displayed on the visual display unit. In such implementations, the user may select the display object 109, and may apply a user filter gesture input to the display object 109 that invokes a database FILTER command. For example, the user may flick the display object 109 out of the field of view displayed on the visual display unit. In such implementations, the VQB may identify that the user wishes to apply a FILTER command, based on the attributes of the object 109, to the search results of the other display objects being displayed on the visual display unit. The VQB may identify the metadata attributes and/or attribute values that were unique to (or emphasized in the search that resulted in the creation of) display object 109. Upon identifying the necessary metadata attributes and/or attribute values, the VQB may initiate modification searches for any previously performed searches for display objects displayed on the visual display unit. The VQB may, in the initiated modification searches, eliminate or apply a negative weight to the attribute and/or attribute values emphasized in the display object 109 to which the user applied the filter gesture input.

As an exemplary non-limiting illustration, consider a scenario where a display object may include a number of search result display objects surrounding it. For example, the VQB may have generated the search result display objects based on a search query that included the metadata keywords “horse,” “guitar,” “blues,” “purple,” and “shoes.” For example, the search result display objects generated may include a video of a horse running, an audio clip of a guitar riff (e.g., with a visualization of audio frequencies), an article about blues guitar, and a pair of purple shoes. The purple shoes may have metadata keywords “purple” and “shoes” associated with it. A user may not be interested in the purple shoes, and may apply a filter gesture input (e.g., the user may flick the purple shoes object off the display screen). In such an example, in some implementations, the VQB may remove the keywords “purple” and “shoes” from the list of metadata keywords used to generate the search result display objects as part of the FILTER command. The VQB may then generate a modified FILTER search query based only on the metadata keywords “horse,” “guitar,” and “blues”, and may provide the modified (based on the FILTER command) search query to the search engine(s) and/or database(s). Based on the search results received in response to the modified FILTER search query, the VQB may update the search result display objects for each of the main display objects on the screen to reflect the user's desire to filter “purple” and “shoes” out of the search results.

In some implementations, the VQB may obtain a large number of relevant search results in response to an initiated search. In other implementations, the VQB may not yet have initiated searches, and may be displaying objects selected from among a variety of topics that may be of interest to the user. In the implementations such as the above, the user may wish to browse through a number of display objects that may not be initially displayed on the visual display unit, yet may be of interest to the user. In such implementations, the VQB may provide the user with a mechanism to refresh the view of display objects being presented on the visual display unit. For example, with reference to FIG. 1C, the VQB may arrange, e.g. in, the initial palette of display objects around a refresh display object. The initial palette of display objects may be floating around the refresh display object. The user may activate the refresh button/object, e.g., by pressing/selecting 113 the refresh display object. Upon obtaining the user refresh gesture input, the VQB may obtain additional display objects relevant to the display objects palette that the user applied the refresh gesture input, and may replace/cycle, e.g. 114, the display objects initially surrounding the refresh display object with new display objects that may be relevant to the user. In alternate implementations, a display object may already have related search result display objects surrounding it displayed on the display unit. Upon the user selecting the display object again (e.g., without providing any other input), the VQB may refresh the search results associated with the display object (e.g., a database REFRESH command). For example, the VQB may cycle through other related search result display objects not previously displayed in proximity to the display object (e.g., analogous to receiving a second web page of search results in a text-based search engine interface).

Referring to FIG. 1D, a user may be interested in a display object that appeared upon the user providing a refresh gesture input, or one that appeared as a search result display object for a search performed by the VQB. In some implementations, the user may select 114 such a display object, e.g., 115. The VQB may, in response to the user selection of the display object 115, initiate a search based on the attributes of the display object 115. Upon obtaining the results of such a search, the VQB may arrange the display object 115 at the center of the search result display objects, and may arrange the search result display objects around the selected display object 115. For example, the VQB may move the selected display object 115 to replace the refresh display object (or prior display object for which the VQB performed the search) at the center of the arrangement. The VQB may then arrange search result display objects, e.g. 117a-c, around the selected display object 115.

Referring to FIG. 1E, in some implementations, the VQB may perform a search related to a display object, e.g. 118, using metadata, e.g. 119, associated with the display object. The VQB may obtain metadata related to the display object based on the results of a previous search initiated by the VQB. In other implementations, the user may specify metadata attributes for a display object that the user would like to see displayed on the visual display unit. For example, the VQB may provide the user with a virtual keyboard into which the user may type in metadata attributes and/or other keywords based on which the VQB may initiate a search for display objects. In some implementations, the metadata may include a variety of attributes (or fields) having attribute values. For example, the metadata may include fields such as, but not limited to: class, type, designed, genre, agency, model, year, rating, stores, pricing, accessories_list, and/or the like. For example, the VQB may obtain display object metadata as a data structure encoded according to the eXtensbile Markup Language (“XML”). An exemplary XML-encoded data structure including display object metadata is provided below:

```
<?XML version = “1.0” encoding = “UTF-8”?>
<object_metadata>
  <timestamp>2010-06-15 09:23:47</timestamp>
  <object_id>f72nf85q</object_id>
  <object_name>Jimi Hendrix guitar</object_name>
  <search_parent_object>f74nc72n</search_parent_object>
  <attributes>
      <class>fashion</class>
      <type>dress</type>
      <designer>ABC</designer>
      <agency>XYZ</agency>
      <year>1989</year>
      <model>MNOP</model>
      <rating>3.0/5.0</rating>
      <stores>
          <nameJ.C.Renney></name>
          <name>Macie's</name>
      </stores>
      <price>299.99</price>
      <accessories>
          <name>necklace</name><ac_id>fj28fjt5</ac_id>
          <name>earrings</name><ac_id>fj28fjt4</ac_id>
          <name>nosering</name><ac_id>fj28fjt6</ac_id>
      </accessories>
  </attributes>
</object_metadata>
```

In some implementations, the VQB may initiate a search for display objects based on metadata obtained about a display object being selected by the user. The VQB may generate one or more search queries based on the obtained metadata, and provide the generated queries to one or more search engines. For example, the VQB may provide queries to a variety of search result sources, including, but not limited to: local and/or remote database(s) using Structured Query Language (“SQL”) commands, provide application programming interface (“API”) calls to local and/or external search engines and/or the like, as discussed further below with reference to FIG. 2. The VQB may obtain search results from the various search sources that it queried, and may aggregate the responses from the sources. The VQB may determine the relevance of each search result to the queries, and may, in some implementations, generate a search ranking of the returned search results from the various sources. The VQB may utilize the search rankings and/or relevance to determine the selection and/or arrangement of search result display objects in proximity to the display object for which the VQB initiated the search. Referring to FIG. 1F, in some implementations, the VQB may arrange the centroids of the search result display objects along the circumference of one or more circles centered on the centroids of display object for which the search was initiated. In some implementations, the display objects may be circling, e.g., in an orbital path around the display object, along the circumference of one or more concentric circles around the display object. Also, in such an embodiment, selecting objects may stop the orbiting trajectories allowing for easier user interaction. For example, a user may have selected display object 120. In response to the user's selection, the VQB may initiate a search for search result display objects using the metadata related to display object 120. The VQB may obtain search results, and generate search result objects 121a-f based on the received search results. The VQB may also obtain metadata for the search result objects 121a-f. The VQB may determine the relative relevance and/or search rankings of the search result objects 121a-f to the display object 120 based on a comparison of the metadata of the objects and/or any relevance and/or ranking data provided by the search engine(s) which provided the search results. The VQB may then arrange the search result objects 121a-f according to the search relevance and/or rankings. For example, the VQB may determine that search result object 121a-c are more relevant to the display object 120 then search result objects 121d-f. In such an example, the VQB may, in some implementations, arrange the search result objects as illustrated in FIG. 1F, wherein the more relevant and/or higher ranked search result objects 121a-c are arranged closer to selected display object 120 than the less relevant and/or lesser ranked search result objects 121d-f. In some implementations, the VQB may generally arrange the search result display objects such that the distance between the centroids of the search result objects and the selected display object increases as the relevance and/or ranking of search results objects with respect to the selected display object decreases.

In some implementations, the VQB may implement proximity JOIN search queries for two or more display objects upon detecting that the user wishes to initiate proximity JOIN queries for the display objects. Referring to FIGS. 1G-J, the VQB may be displaying two main display objects, e.g., 124 and 125, along with search result objects 126a-f and 127a-f related to display objects 124 and 125 respectively. Initially, the distance separation between the centroids/outer boundaries of the display objects 124 and 125 may be larger than a threshold value to initiate proximity JOIN search queries related to the display objects 124 and 125. Alternatively, the user may not yet have selected the display objects 124 and 125 in such a manner as to convey to the VQB that the user wishes to perform a proximity JOIN search query. In such scenarios, the VQB may utilize only the metadata 124a-j of display object 124 to generate a query for the search result display objects 126a-f surrounding display object 124. Similarly, the VQB may utilize only the metadata 125a-j of display object 125 to generate a query for the search result display objects 127a-f surrounding display object 125. Accordingly, at an initial time, the VQB may not have implemented cross-over influence of metadata from one display object to another display object's search results. At a later time, the user may select the objects 124 and 125, and, e.g., may drag them towards each other, as depicted in FIG. 1H. The VQB may continuously monitor the separation between the display objects 124 and 125. Upon detecting that the monitored separation is less than a threshold value, the VQB may determine that the user wishes for the VQB to perform proximity JOIN search queries related to the display objects 124 and 125. Based on the separation between the display objects 124 and 125, the VQB may determine an amount of metadata cross-over to incorporate into the proximity JOIN search queries. For example, in the illustration depicted in FIG. 1H, the user may moved the display objects 124 and 125 closer to each other. The VQB may determine, based on the (reduced) separation between the display objects 124 and 125, that three metadata fields (124a-c, 125a-c respectively) from each display object may be utilized to generate search queries for search result display objects that may surround the other display object. In various implementations, the VQB may choose the metadata fields that are to be crossed over in a variety of ways, including, but not limited to: (i) randomly; (ii) the fields that are most in common between the two display objects; (iii) the fields that are least in common between the two display objects; (iv) highest priority values associated with the fields of the metadata of the display objects; (v) lowest priority values associated with the fields of the metadata of the display objects; (vi) prior user interactions with the display objects 124 and 125; (vii) combinations of (i)-(vi) thereof; etc. Upon determining the metadata fields from both display objects that are to be used to generate the queries for each of the display objects 124 and 125, the VQB may generate the proximity JOIN search queries using the appropriate metadata fields, and provide the generated proximity JOIN queries for the search engines. The search engines may provide the search results based on the proximity JOIN queries, using which the VQB may generate appropriate search result display objects, e.g., 128a-f and 129a-f. The VQB may arrange the search results display objects around the display objects 124 and 125 according to the search relevance and/or rankings of the search result display objects with respect to both display objects 124 and 125. For example, two search results objects 128b and 128f may be considered equally relevant to display object 124. However, search result object 128b may be considered more relevant to display object 125 than search result object 128f. Accordingly, the VQB may arrange search result object 128b closer to display object 125 than search result object 128f, while maintaining the search result objects 128b and 128f equidistant from display object 124. Similarly, the VQB may arrange a search result object of display object 125 that is of greater relevance to display object 124 (e.g., search result object 1290 closer to display object 124 than one having lesser relevance to display object 124 (e.g., search result object 129b). Accordingly, when implementing a plurality of proximity JOIN queries involving a plurality of display objects, the VQB may arrange the search result display objects of each display object in accordance with the search result display objects' relevance to all the other display objects involved in the proximity JOIN query generation. In some implementations, the VQB may display a plurality of display objects across the visual display unit, with a sea of search result display objects occupying the interstices between the display objects, wherein the relevance of the interstitial search result objects gradually varies in the space from one display object to another.

In some implementations, the user may move the display objects 124 and 125 closer together, e.g., as illustrated in FIG. 1I. In such implementations, the VQB may determine that the display objects 124 and 125 are sufficiently close (e.g., by comparing the separation against a threshold value) that the display objects may share search result objects. For example, display objects 124 and 125 share search result objects 132a-c. The VQB may determine, based on the proximity of the display objects 124 and 125, that a significant cross-over of metadata from one display object to another is requested/implied by the user. For example, in the illustration of FIG. 1I, the VQB may determine that half of the metadata (e.g., 124a-e, 125a-e) of each display object is to be utilized in query generation for search result objects for the other display object. The VQB may generate proximity JOIN queries for the two display objects 124 and 125 using significant metadata cross-over for each of the display objects. The VQB may provide the search queries for the search engines, and obtain the search result objects, e.g., 130a-d, 131a-d and 132a-c. Of these, the VQB may consider the search result objects 132a-c to be equally relevant to both display objects 124 and 125. Accordingly, the VQB may arrange the search result objects 132a-c such that they are equidistant (or nearly equidistant) between the display objects 124 and 125. The VQB may arrange the other search result objects, 130a-d and 131a-d (that are distinguished as being more relevant to display objects 124 and 125 respectively), according to the procedure as discussed previously with reference to FIGS. 1F-H.

In some implementations, the user may select display objects 124 and 125 and move them further closer to each other. In such implementations, the VQB may determine that the user wishes to perform a complete JOIN operation on the two display objects. For example, the VQB may determine that a complete JOIN operation is requested when the boundaries of the two display object 124 and 125 are within a specified threshold, or once they touch each other, overlap, etc. The VQB may generate a composite display object comprising the two display objects 124 and 125, e.g., as illustrated in FIG. 1J. The VQB may then consider the combined metadata of the two display objects 124 and 125, to be the metadata for the composite display object. The VQB may accordingly generate a single unified JOIN query for the composite object using the metadata for both constituent display objects equally for the query. The VQB may provide the query for the search engine(s), and obtain search results for the JOIN query. The VQB may generate a single relevancy and/or ranking that assesses the relevancy of the search result display objects to the composite object. The VQB may arrange the JOIN search result display objects around the entirety of the composite object, with all search result display objects being equally relevant to the constituent display objects of the composite display object. In some implementations, the VQB may consider the composite object to be similar to any other display object, and may continue to perform operations on the composite object consistent with the VQB's operations on normal display objects. In some implementations, the user may pull the display objects included in the composite objects back apart from each other, and the VQB may decompose the composite object such that the display objects have their own separate search results. In another example, the user may drag the display objects away off to a retraceable search log history area 134, thereby minimizing the pulled away object 134a and search results into a size decreasing bread-crumb-trail miniature 134a-134. A user may retrace his or her previous search query states by selecting any of the miniature bread crumbs and restore that search state to visual prominence, as for example, depicted in FIG. 1J back to FIGS. 1I1G.

Referring to FIG. 1K, in some implementations, the user may wish to apply a FILTER command to the search result objects, e.g., 133a-h, of a composite display object (or a normal display object). The user may, for example, apply a user filter gesture input (e.g., such as flicking an object away) to one of the search result display objects, e.g., 133d. In such implementations, the VQB may identify that the user wishes to apply a FILTER command to the search result display object, e.g., 133d. The VQB may analyze the relevancy of the search result display object subject to the FILTER command to the metadata attributes of the composite display object. Based on the analysis, the VQB may identify metadata attributes of the composite display object to which the search result display object subject to FILTER command is most relevant. In some implementations, the VQB may generate new search queries excluding these identified metadata attributes. For example, with reference to FIG. 1K, the VQB may determine that search result object 133d is most relevant to metadata attributes 124g and 125d-e. The VQB may generate new search queries excluding these metadata attributes, and provide the queries to the search engine(s). Upon obtaining search results from the search engine(s), the VQB may modify the search result display objects (133a*-h*) accordingly.

FIG. 2 is of a data flow diagram illustrating exemplary aspects of implementing aggregated multi-search engine or other database processing of visually built queries in some embodiments of the VQB. In some implementations, a user 201 may wish to interact with the objects displayed on a visual display unit of a client, e.g., For example, the user may provide input, e.g., user touch input 211 into the client device. In various other implementations, the user input may include, but not be limited to: keyboard entry, mouse clicks, depressing buttons on a joystick/game console, (3D; stereoscopic, time-of-flight 3D, etc.) camera recognition (e.g., motion, body, hand, limb, facial expression, gesture recognition, and/or the like), voice commands, single/multi-touch gestures on a touch-sensitive interface, touching user interface elements on a touch-sensitive display, and/or the like. The client may identify the user commands, and manipulate the display objects on the visual display unit. Based on the user input and the manipulation of the display objects, the client may identify a user search request. The client may, in response, generate one or more search queries, e.g., 212. The client may then provide the search queries for processing, e.g., SELECT search query 213a . . . proximity JOIN search query 213n, to search engine(s), e.g., 204, and/or database(s), e.g., 205c. For example, the client server may provide a (Secure) HyperText Transport Protocol (“HTTP(S)”) POST message with a search query for the search engine(s) and/or database(s). For example, the HTTP(S) POST message may include in its message body the user ID, client IP address etc., and search terms for the search engine(s) and/or database(s) to operate on. An exemplary search query HTTP(S) POST message is provided below:

```
POST /query.php HTTP/1.1
Host: www.searchengine.com
Content-Type: Application/XML
Content-Length: 229
<?XML version = “1.0” encoding = “UTF-8”?>
<search_query>
    <request_id>AJFY54</request_id>
    <timestamp>2010-05-23 21:44:12</timestamp>
    <user_ID>username@appserver.com</user_ID>
    <client_IP>275.37.57.98</client_IP>
    <search_logic>jendrix AND blues AND 1968</search_query>
</search_query>
```

The client may provide search queries to a plurality of search engines. In response to the client request the search engines may perform a search within the database(s) to which the search engines are connected. Some of the search engines may access local storage, database(s) and/or local network resources (e.g., internal financial transaction databases, document databases, etc.), while other search engine(s) may perform searches over other domains, e.g., the Internet, external market databases, etc. For example, the search engine may access an search index database, and identify candidate media (documents, images, video etc.) in a search engine database based on the search of the index database, determine rankings for the results, and provide the results, e.g., via HTTP(S) POST messages similar to the example above to the client. Upon obtaining the research results, e.g., 214a . . . 214n, from the search engines, the client may aggregate the results from all the search engines and generate rankings for the top results from the aggregated pool of results. The client may select a subset of the search results for which to generate display objects for display on the visual display connected to the client. Upon selecting the search result subset, the client may from generate display objects corresponding to the search results using the data provided by the search engines. For example, the client may generate a data structure representative of a scalable vector illustration, e.g., a Scalable Vector Graphics (“SVG”) data file. The data structure may include, for example, data representing a vector illustration. For example, the data structure may describe a scalable vector illustration having one or more objects in the illustration. Each object may be comprised of one or more paths prescribing, e.g., the boundaries of the object. Further, each path may be comprised of one or more line segments. For example, a number of very small line segments may be combined end-to-end to describe a curved path. A plurality of such paths, for example, may be combined in order to form a closed or open object. Each of the line segments in the vector illustration may have start and/or end anchor points with discrete position coordinates for each point. Further, each of the anchor points may comprise one or more control handles. For example, the control handles may describe the slope of a line segment terminating at the anchor point. Further, objects in a vector illustration represented by the data structure may have stroke and/or fill properties specifying patterns to be used for outlining and/or filling the object. Further information stored in the data structure may include, but not be limited to: motion paths for objects, paths, line segments, anchor points, etc. in the illustration (e.g., for animations, games, video, etc.), groupings of objects, composite paths for objects, layering information (e.g., which objects are on top, and which objects appear as if underneath other objects, etc.) and/or the like. For example, the data structure including data on the scalabale vector illustration may be encoded according to the open XML-based Scalable Vector Graphics “SVG” standard developed by the World Wide Web Consortium (“W3C”). An exemplary XML-encoded SVG data file, written substantially according to the W3C SVG standard, and including data for a vector illustration comprising a circle, an open path, a closed polyline composed of a plurality of line segments, and a polygon, is provided below:

```
<?XML version = “1.0” standalone = “no”>
<!DOCTYPE svg PUBLIC “-//W3C//DTD SVG 1.1//EN”
    “http://www.w3.org/Graphics/SVG/1.1/DTD/svg11.dtd”>
<svg width = “100%” height = “100%” version = “1.1”
    xmlns=“http://www.w3.org/2000/svg”>
    <circle cx=“250” cy=“75” r=“33” stroke=“blue”
    stroke-width=“2” fill=“yellow”/>
    <path d=“M250 150 L150 350 L350 350 Z” />
    <polyline points=“0,0 0,20 20,20 20,40 40,40 40,80”
    style=“fill:white;stroke:green;stroke-width:2”/>
    <polygon points=“280,75 300,210 170,275”
    style=“fill:#cc5500;
    stroke:#ee00ee;stroke-width:1”/>
</svg>
```

The client may render, e.g. 215, the visualization represented in the data structure for display to the user. For example, the client may be executing an Adobe®Flash object within a browser environment including ActionScript™ 3.0 commands to render the visualization represented in the data structure, and display the rendered visualization for the user. Exemplary commands, written substantially in a form adapted to ActionScript™ 3.0, for rendering a visualization of a scene within an Adobe® Flash object with appropriate dimensions and specified image quality are provided below:

// import necessary modules/functions
import flash.display.BitmapData;
import flash.geom.*;
import com.adobe.images.JPGEncoder;
// generate empty bitmap with appropriate dimensions
var bitSource:BitmapData = new BitmapData (sketch_mc.width,
sketch_mc.height);
// capture snapsot of movie clip in bitmap
bitSource.draw(sketch_mc);
var imgSource:Image = new Image( );
imgSource.load(new Bitmap(bitSource, “auto”, true));
// generate scaling constants for 1280 × 1024 HD output
var res:Number = 1280 / max(sketch_mc.width, sketch_mc.height);
var width:Number = round(sketch_mc.width * res);
var height:Number = round(sketch_mc.height * res);
// scale the image
imgSource.content.width = width;
// JPEG-encode bitmap with 85% JPEG compression image quality
var jpgEncoder:JPGEncoder = new JPGEncoder(85);
var jpgStream:ByteArray = jpgEncoder.encode(jpgSource);

In some implementations, the client may continuously generate new scalable vector illustrations, render them in real time, and provide the rendered output to the visual display unit, e.g. 216, in order to produce continuous motion of the objects displayed on the visual display unit connected to the client. In some implementations, the VQB may contain a library of pre-rendered images and visual objects indexed to be associated with one or more of search result terms or phrases, such as the Clip Art files, e.g., accessible through Microsoft® PowerPoint application software.

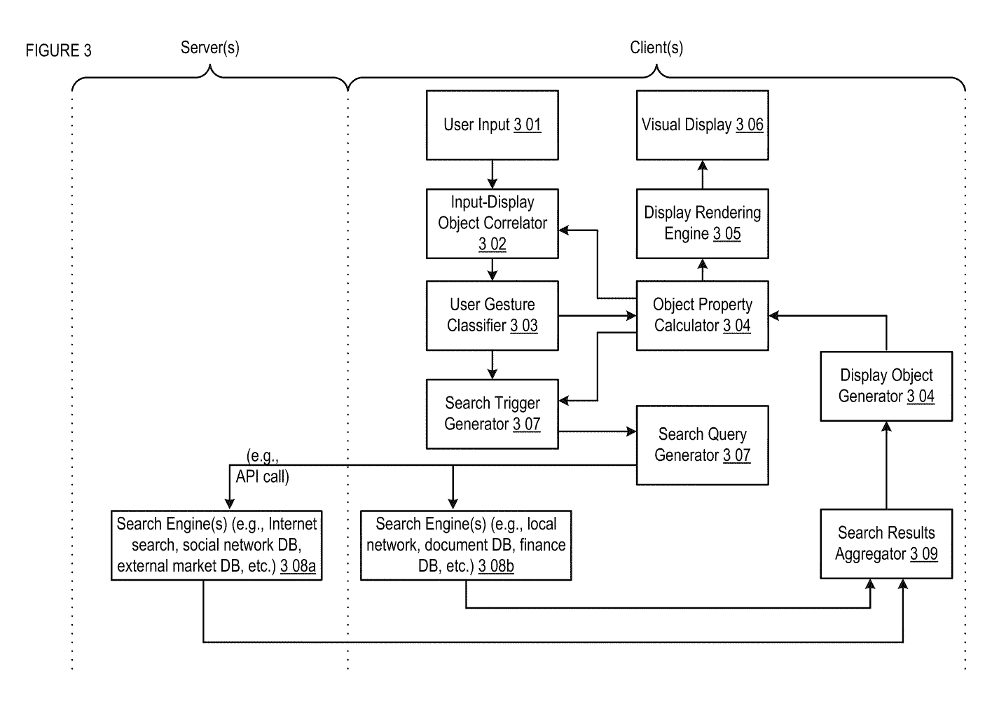

FIG. 3 is of a block diagram illustrating various exemplary visual query builder components in some embodiments of the VQB. In some implementations, the VQB may include a plurality of components to transform the user's gesture input into visual queries for submission to search engines and render the search engine results into a visual display objects for the user to manipulate. For example, the VQB may include a user input component 301 to accept raw user input (e.g., touch-based input on a touch-sensitive trackpad, screen etc.). An input-display object correlator 302 may obtain the user input, map the input to a pixel subarea within the display, identify a visual display object associated with the pixel subarea, and assign the user input to the object associated with the pixel subarea. A user gesture classifier 303 may obtain all user inputs assigned to a visual display object, and classify the user inputs (e.g., swipes of several fingers across the touch-sensitive surface) as one of the available gestures stored in a memory of the VQB. Accordingly, the user gesture classifier may identify the type of gesture that the user is performing on the visual display object. The object property calculator 304 may calculate the geometrical transformation (e.g. acceleration, velocity, position, rotation, revolution, etc.) that the VQB must apply to the visual display object based on the user gesture classified by the user gesture classifier. A display rendering engine 305 may obtains the geometrical transformations calculated by the object property calculator, and generate a data structure representative of the new object geometrical properties. The display rendering engine may then render a new visual rendered output for display to the user. The visual display unit 306 may project the rendered output for visualization by the user.

A search trigger generator 307 may continuously monitor the user gestures classified by the user gesture classifier, and the object geometrical properties (e.g., position, acceleration, velocity, etc.) to determine whether the user wishes for a search to be performed. If the search trigger generator identifies a user search request in the gesture(s) provided by the user, the search trigger generator alerts a search query generator 307 to generate the required search queries and provide the information required for the search query generator to generate the required search queries. The search query generator 307 generates the search queries using the object metadata and object geometrical properties obtained from the search trigger generator, and provide the generated search queries to one or more search engine(s), which may reside on the client and/or server side of the VQB. The search engine(s) may return search results for the client-side processing. A search results aggregator 309 may obtained the returned search results, aggregate them into a pool of search results, and determine relevancy information and ranking information for each search result in the pool of search results. The search results aggregator may also record a log of the searches submitted to the search engines, and may maintain a retraceable record of the searches and search results produced. The search results aggregator may provide the display object 304 generator with the current and/or prior search results for generating renderable display objects. The display object generator 304 may generate new display object (e.g., generating an XML-encoded SVG data structure) using the search results provided by the search results aggregator. The display object generator 304 may provide the generated display objects for the object property calculator 304, thereby introducing new visual display objects into the rendered output provided to the user via the visual display 306.

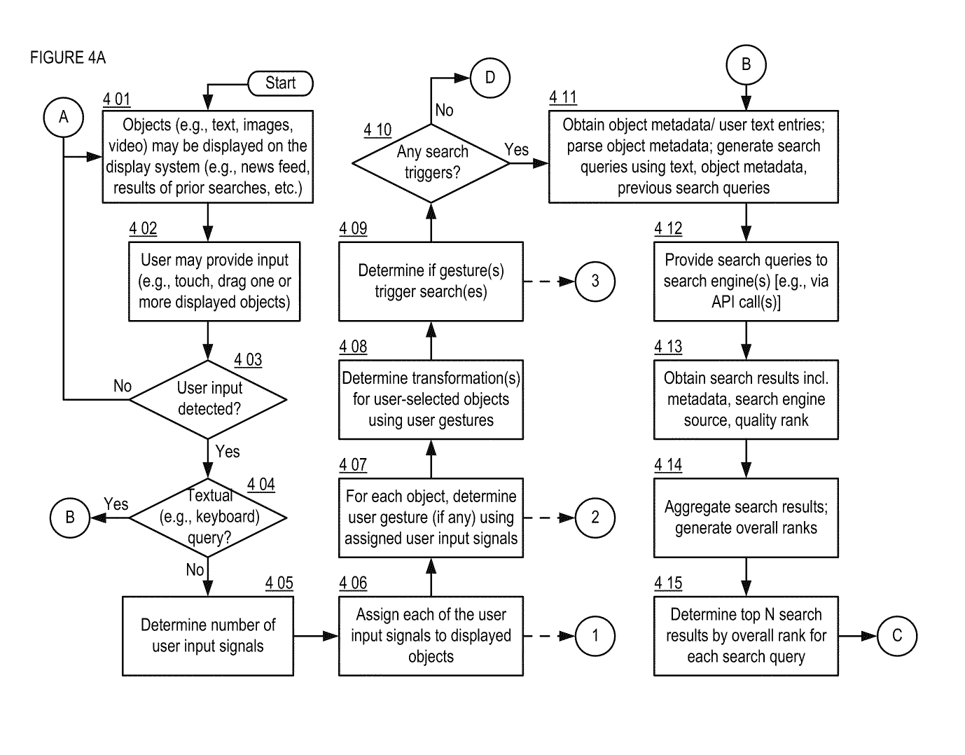

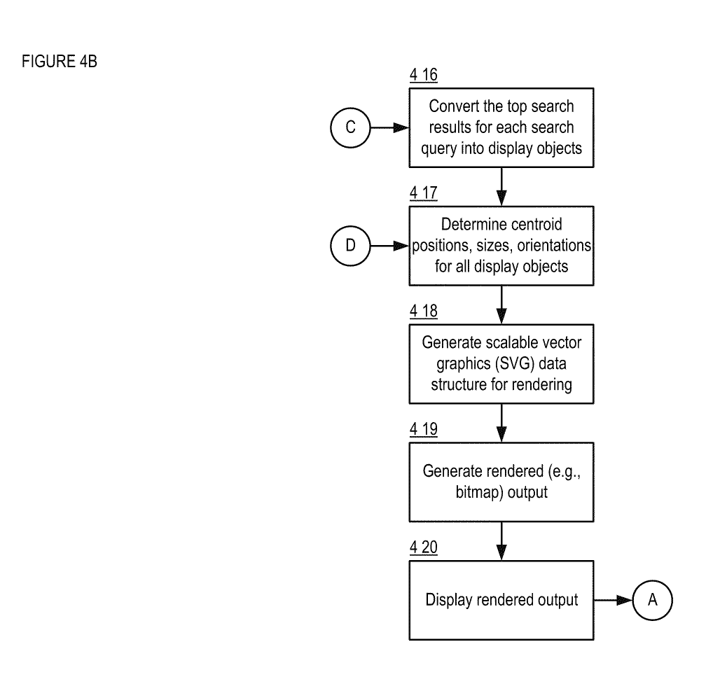

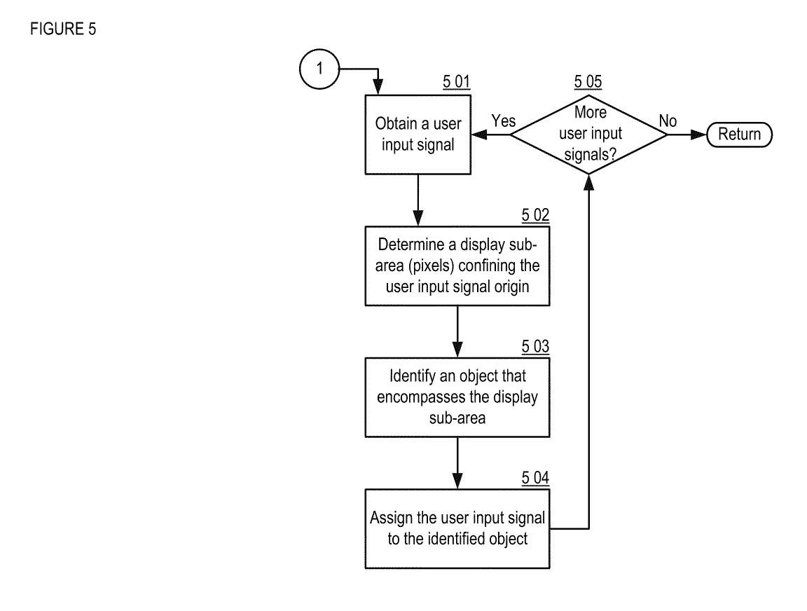

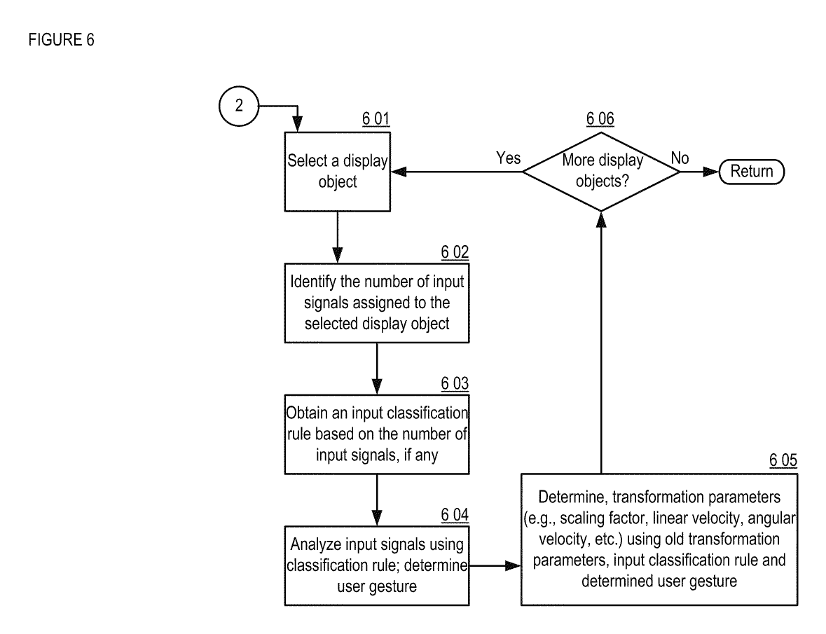

FIGS. 4A-B are of logic flow diagrams illustrating exemplary aspects of visually building queries to submit for aggregated multi-search engine processing in some embodiments of the VQB, e.g., a Visual Query Builder (“VQB”) component 400. In some implementations, visual display objects may be displayed 401 in the display system. For example, the visual display system may be displaying news feed, top stories from news aggregators, popular websites, images, videos and/or the like, results of the most popular searches, etc. A user may provide an input 402 into the VQB. For example, the user may provide a SELECT, JOIN, FILTER, drag, flick, rotate, scale and/or other gesture to the VQB. For example, the gesture may include a single finger press, single finger swiping motion, multi-touch slide, swipe, drag, finger-spread, typing into a displayed virtual keyboard, and/or the like. If the VQB detects the user input (e.g., 403, Option Yes), the VQB may determine whether the input is text input, e.g., into a manual/virtual keyboard. If the input is a text entry (e.g., 404, Option Yes), the VQB may directly generate search queries and provide them to the search engines. If the user input is determined to be a non-textual entry (e.g., 404, Option No), the VQB may determine the number of input signals 405. For example, the VQB may determine the number of fingers on a touch-sensitive surface based on the output of the digitizer operatively connected to the touch-sensitive surface (e.g., LCD digitizer on smartphones). The VQB may assign 406 the user inputs to a displayed object. For example, the VQB may utilize the pixels positions provided by the digitizer to correlate the user input position to a displayed object, as discussed further below with regard to FIG. 5. For each object, the VQB may determine if a user gesture (if any) was intended by the user, based on the user input signals assigned to the objects as discussed further below with regard to FIG. 6. The VQB may then calculate the geometrical transformation 408 (e.g., rotation, scaling, x-position, y-position, x-velocity, y-velocity, x-acceleration, y-acceleration, etc.) for each displayed object based on the user-provided gesture assigned to the object as well as any prior trajectory assigned to the object prior to (or in the absence of) an assigned user gesture. Upon transforming the geometrical positions of the displayed objects, the VQB may determine whether any searches need be performed based on the user gestures and the geometrical transformations to the displayed objects. If any search triggers are found (e.g., 410, Option Yes), the VQB may obtain the object metadata and/or any user textual entries, parse the object metadata, e.g., using a Simple Object Access Protocol (“SOAP”) parser for XML metadata, and generate 411 search queries based on the parsing of the metadata (e.g., similar to the HTTP(S) POST messages with XML-encoded message body as described earlier in this disclosure) and any prior search queries (e.g., for modifying composite object metadata and search related display objects using a FILTER action). The VQB may provide 412 the generated search queries to search engine(s), e.g., using HTTP(S) POST messages, Structured Query Language (“SQL”) commands, application programming interface (“API”) calls, etc. Upon obtaining the search results 413 including metadata, search relevance information, search rank information, etc., from the search engine(s), the VQB may aggregate 414 the search results, and generate overall search ranks. In some implementations, the VQB may determine 415 the top N (N being an integer) ranked search results for each of the search queries that were sent to the search engines. For example, the VQB may aggregate the search results, and apply a ranking procedure to determine the most relevant search results for the user. The VQB may, in some implementations, utilize a learning algorithm (e.g., artificial neural network) to mine the search history of the user to learn the most popular searches performed by user(s) and the display objects that receive the greatest number of hits from the user(s). In some implementations, the VQB may utilize a combination of the search relevance indicators from the search engines and the VQB's ranking procedure to determine the top N search results. The VQB may convert 416 the determined top N search results into display objects (e.g., by obtaining snapshots of text, images, video, etc. from the search engine results, extracting hyperlinks via parsing the search results and downloading/streaming the media using the hyperlinks, obtaining Really Simple Syndication “RSS” feeds, Financial Information eXchange “FIX” and/or other market data feeds, widgets, webpage/HTML/XML/executable code snippets, etc.), and determine the geometrical transformations 417 (e.g., determine centroid position, object size, object orientation, etc.) for the display objects using the search ranking, relevance, display characteristics, etc. The VQB may then generate 418 the scalable vector graphics (e.g., XML-encoded SVG data structure), render 419 the scalable vector graphics into a visual output (e.g., bitmap frame), and provide the rendered output to the visual display unit of the VQB for display 420 to the user. The VQB may also generate display objects 416 by selecting from a library of indexed, pre-rendered images and visual objects to associate with search results 413. The VQB may further generate display objects by extracting hyperlinks from the obtained search results, and downloading/streaming the content associated with the hyperlinks. The VQB may further generate display objects by acquiring RSS feeds, financial market data feeds (e.g., FIX, FAST protocol feeds, etc.) and/or the like real-time data.

FIG. 5 is of a logic flow diagram illustrating exemplary aspects of correlating complex multi-dimensional, multi-user input to visual display objects in some embodiments of the VQB, e.g., an Input-Display Object Correlation (“IDOC”) component 500. In some implementations, the VQB may assign each user-provided physical input (e.g., finger swipe) to an object displayed on the visual display unit. The VQB may obtain 501 a user input signal and determine (e.g., by obtaining x and y pixel information from a digitizer of an LCD touchscreen of a smartphone) a display pixel subarea that confines the user input signal origin. The VQB may identify an object that encompasses the display pixel subarea, e.g., by correlating the x and y pixels position of the user input to the object positions (e.g., from an XML-encoded SVG data structure) render on the visual display. Upon identifying the display object to which the user input should be assigned, the VQB may add a field to a display object data structure indicating the assignment of the user input to the display object. The VQB may repeat the above procedure until all input signals provided have been assigned to display objects.

FIG. 6 is of a logic flow diagram illustrating exemplary aspects of classifying into gestures the multi-dimensional, multi-user inputs correlated to visual display objects in some embodiments of the VQB, e.g., a User Gesture Classification (“UGC”) component 600. In some implementations, the VQB may analyze the user inputs assigned to each object displayed on the visual display unit to determine if any user gesture was provided to the displayed object, and the nature of the gesture provided by the user to the displayed object. The VQB may select 601 a display object and identify 602 the number of user input signals (e.g., representative of the number of fingers) assigned to the selected display object. The VQB may obtain an input classification rule 603 from a memory resource (e.g., instructions stored in client-side read-only-memory) based on the number of user input signals (e.g., number of fingers). The VQB may analyze 604 the input signals (e.g., are the fingers diverging/converging? What is the rate of motion of the fingers?, etc.), and determine 605 the user gesture based on applying the classification rule to the user input signals assigned to the select display object. The VQB may repeat the above procedure until all display objects have either been processed according to the above procedure.

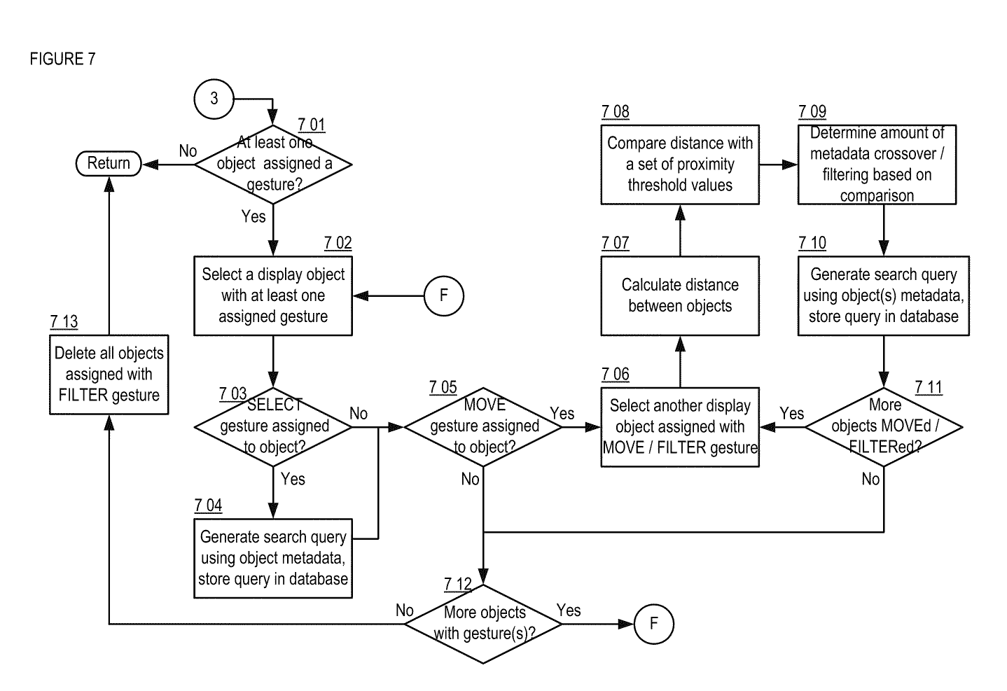

FIG. 7 is of a logic flow diagram illustrating exemplary aspects of triggering generation and submission of user input gesture derived queries in some embodiments of the VQB, e.g., a Search Trigger Generation (“STG”) component 700. In some implementations, the VQB may generate queries based on the user gesture inputs provided by the user. If there are no user gestures provided by the user, the VQB may exit the STG component procedure (e.g., 701, Option No). If there is at least one user input gesture, the VQB may continue the procedure. The VQB may select 702 a display object having at least one user gesture assigned to it, and analyze the gesture assigned to the display object. If the object is assigned a SELECT gesture, the VQB may generate a search query based on the metadata of the object and store the query in a database. If the VQB determines that a MOVE gesture (e.g., user dragging/pushing object on screen) is present (e.g., 705, Option Yes), the VQB may compare the position of the selected display objects against all other display objects that have also been assigned MOVE gesture to determine if any proximity JOIN queries need to be generated for those display objects. The VQB may iteratively perform the below procedure in such a case.

The VQB may select 706 another display object also assigned a MOVE gesture. The VQB may calculate 707 the distance between the two objects (e.g., distance between centroids, distance between their closest boundaries, etc.). For example, the VQB may obtain the x and y pixel values of the centroid of the two display objects. Consider an example where the initial (x,y) pixel values for the centroid of a display object 1 are (10,253), and the initial (x,y) pixel values for the centroid of a display object 2 are (1202, 446). The VQB may calculate the initial distance between the centroids of the two display objects as ((1202−10)²+(446−253)²)^{1/2} or 1207 pixels. Consider an example where the user moves the display object 1 such that the new position of its centroid is (55,378) and the user moves display object 2 such that the new position of its centroid is (801, 400). The VQB may calculate the new distance as ((801−55)²+(400−378)²)^{1/2} or 746 pixels. In some implementations, the VQB may compare the raw proximity difference against a set of threshold values (e.g., threshold to begin metadata crossover, thresholds for 20%, 40%, 60%, 80%, etc. metadata crossover, threshold for composite object generation (100% crossover), etc.):
If proximity difference (PD)<=200, then metadata crossover=100%
If 200<proximity difference (PD)<=400, then metadata crossover=80%
If 400<proximity difference (PD)<=600, then metadata crossover=60%
If 600<proximity difference (PD)<=800, then metadata crossover=40%
If 800<proximity difference (PD)<=1000, then metadata crossover=20%

Based on the comparison, the VQB may determine an amount of metadata crossover (e.g., from 0% (no crossover)-100% (composite object)) to implement between the two display objects. In some implementations, the VQB may calculate a raw proximity difference (e.g., of 1207−746 or 461 pixels for the example above), and calculate a percentage change (e.g., as (1207−746)*100/1207 or 38% for the example above). The VQB may utilize these proximity difference and/or percentage change values to determine the amount of metadata crossover.

In some implementations, the VQB may also determine whether the distance is greater than a filter threshold value, in which case the VQB may determine the object being filtered out based on the object positions within the display (e.g., filtered object may be outside the pixel value boundaries for display). The VQB may also determine the type of metadata to filter out from the search queries, and may store the filtering data in a database. The VQB may generate search queries 710 based on the determination of the crossover/filtering amount. The VQB may repeat the above procedure iteratively (e.g., 711, Option Yes) until all other display objects assigned with a MOVE user gesture are compared against the selected display object to determine whether an proximity JOIN/FILTER search queries need to be generated. In some implementations, the VQB may repeat a similar procedure for SELECT, MOVE, and FILTER gestures for all display objects (e.g., 712, Option Yes), thereby generating all required SELECT, proximity JOIN and FILTERed search queries.

### VQB Controller

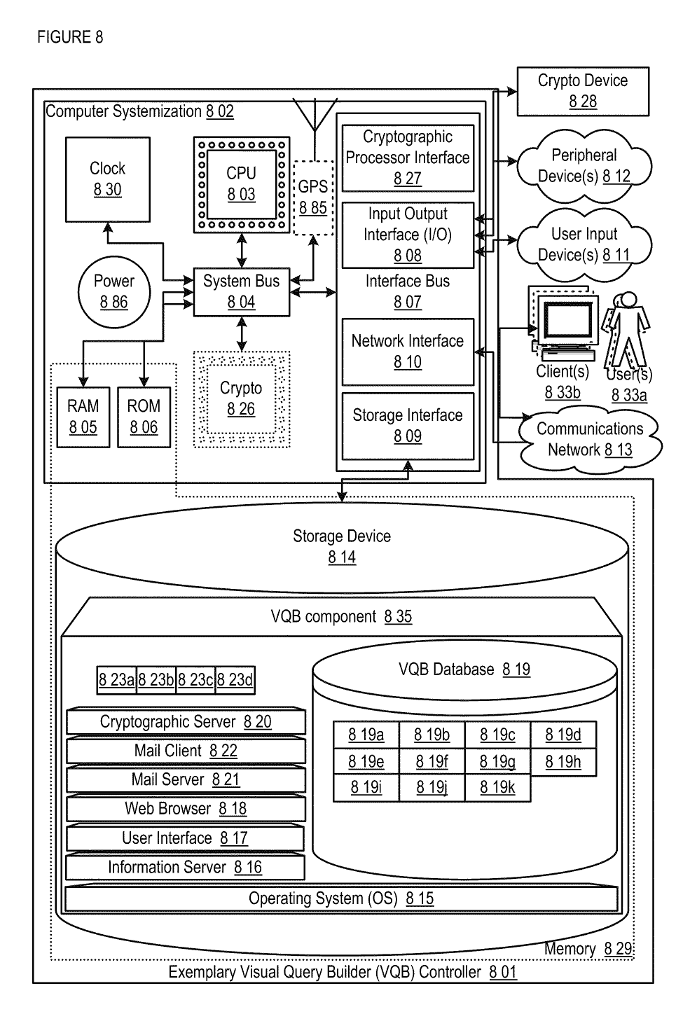

FIG. 8 illustrates inventive aspects of a VQB controller 801 in a block diagram. In this embodiment, the VQB controller 801 may serve to aggregate, process, store, search, serve, identify, instruct, generate, match, and/or facilitate interactions with a computer through enterprise and human resource management technologies, and/or other related data.

Typically, users, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the VQB controller 801 may be connected to and/or communicate with entities such as, but not limited to: one or more users from user client devices 811; peripheral devices 812; an optional cryptographic processor device 828; and/or a communications network 813. For example, the VQB controller 801 may be connected to and/or communicate with users operating client device(s) including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™ etc.), eBook reader(s) (e.g., Amazon Kindle™ etc.), laptop computer(s), notebook(s), netbook(s), gaming console(s) (e.g., XBOX Live™, Nintendo® DS etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The VQB controller 801 may be based on computer systems that may comprise, but are not limited to, components such as: a computer systemization 802 connected to memory 829.

### Computer Systemization

A computer systemization 802 may comprise a clock 830, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother)board(s) 802 having conductive and/or otherwise transportive circuit pathways through which instructions (e.g., binary encoded signals) may travel to effect communications, operations, storage, etc. Optionally, the computer systemization may be connected to an internal power source 886. Optionally, a cryptographic processor 826 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the VQB controller and beyond through various interfaces. Should processing requirements dictate a greater amount speed and/or capacity, distributed processors (e.g., Distributed VQB), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the VQB may be achieved by implementing a microcontroller such as CAST's R8051XC2 microcontroller; Intel's MCS 51 (i.e., 8051 microcontroller); and/or the like. Also, to implement certain features of the VQB, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the VQB component collection (distributed or otherwise) and/or features may be implemented via the microprocessor and/or via embedded components; e.g., via ASIC, coprocessor, DSP, FPGA, and/or the like. Alternately, some implementations of the VQB may be implemented with embedded components that are configured and used to achieve a variety of features or signal processing.

Depending on the particular implementation, the embedded components may include software solutions, hardware solutions, and/or some combination of both hardware/software solutions. For example, VQB features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the VQB features. A hierarchy of programmable interconnects allow logic blocks to be interconnected as needed by the VQB system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the VQB may be developed on regular FPGAs and then migrated into a fixed version that more resembles ASIC implementations. Alternate or coordinating implementations may migrate VQB controller features to a final ASIC instead of or in addition to FPGAs. Depending on the implementation all of the aforementioned embedded components and microprocessors may be considered the “CPU” and/or “processor” for the VQB.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the VQB thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the VQB controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed VQB), architectures may similarly be employed to pool, load balance, and/or otherwise increase the communicative bandwidth required by the VQB controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 811 may be card readers, dongles, finger print readers, gloves, graphics tablets, joysticks, keyboards, mouse (mice), remote controls, retina readers, trackballs, trackpads, and/or the like.

Peripheral devices 812 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the VQB controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the VQB controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the VQB controller and/or a computer systemization may employ various forms of memory 829. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the VQB component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the VQB controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the VQB controller to communicate with other entities through a communications network 813. Various communication protocols may be used by the VQB controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the VQB controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the VQB database 819, operating systems, other program components, user interfaces, Web browsers, and/or the like.

Access to the VQB database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the VQB. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the VQB as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/5 Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the VQB enabled nodes. The combined application may be nugatory on systems employing standard Web browsers.

### Mail Server

A mail server component 821 is a stored program component that is executed by a CPU 803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the VQB.

Access to the VQB mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the VQB may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the VQB component to engage in secure transactions if so desired. The cryptographic component facilitates the secure accessing of resources on the VQB and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The VQB Database

The VQB database component 819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the VQB database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the VQB database is implemented as a data-structure, the use of the VQB database 819 may be integrated into another component such as the VQB component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 819 includes several tables 819a-k. A Users table 819a may include fields such as, but not limited to: user_ID, first_name, last_name, middle_name, suffix, prefix, device_ID list, device_name_list, device_type_list, hardware_configuration_list, software_apps_list, device_IP_list, device_MAC_list, device_preferences_list. A Metadata table 819b may include fields such as, but not limited to: class, type, designer, agency, year, model, rating, stores, price, accessories_list, genre, style, and/or the like. A SearchResults table 819c may include fields such as, but not limited to: object_ID_list, object_relevance_weight, object_search_rank, aggregate_search_rank, and/or the like. An ObjectProprty table 819d may include fields such as, but not limited to: size_pixels, resolution, scaling, x_position, y_position, height, width, shadow_flag, 3D_effect_flag, alpha, brightness, contrast, saturation, gamma, transparency, overlap, boundary_margin, rotation_angle, revolution_angle, and/or the like. An ObjectProximity table 819e may include fields such as, but not limited to: object1_list, object2_list, proximity_list, and/or the like. A SearchTrigger table 819f may include fields such as, but not limited to: metadata_depth_list, threshold_list, object_type, trigger_flags_list, and/or the like. A PositionRules table 819g may include fields such as, but not limited to: offset_x, offset_y, search_relevance_object_ID_list, search_rank_object_ID_list, and/or the like. An ObjectTransformation table 819h may include fields such as, but not limited to: acceleration, velocity, direction_x, direction_y, orientation_theta, orientation_phi, object_mass, friction_coefficient_x, friction_coefficient_y, friction_coefficient_theta, friction_coefficient_phi, object_elasticity, restitution_percent, terminal_velocity, center_of_mass, moment_inertia, relativistic_flag, newtonian_flag, and/or the like. A PhysicsDynamics table 819i may include fields such as, but not limited to: collision_type, dissipation_factor, and/or the like. A Gestures table 819j may include fields such as, but not limited to: gesture_name, gesture_type, assoc_code_module, num_users, num_inputs, velocity_threshold_list, acceleration_threshold_list, pressure_threshold_list, and/or the like. A CompositeObjects table 819k may include fields such as, but not limited to: object_ID_list, metadata_include_array, metadata_exclude_array, and/or the like. One or more of the tables discussed above may support and/or track multiple entity accounts on a VQB.

In one embodiment, the VQB database may interact with other database systems. For example, employing a distributed database system, queries and data access by search VQB component may treat the combination of the VQB database, an integrated data security layer database as a single database entity.

In one embodiment, user programs may contain various user interface primitives, which may serve to update the VQB. Also, various accounts may require custom database tables depending upon the environments and the types of clients the VQB may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-k. The VQB may be configured to keep track of various settings, inputs, and parameters via database controllers.

The VQB database may communicate to and/or with other components in a component collection, including itself, and/or facilities of the like. Most frequently, the VQB database communicates with the VQB component, other program components, and/or the like. The database may contain, retain, and provide information regarding other nodes and data.

### The VQBs

The VQB component 835 is a stored program component that is executed by a CPU. In one embodiment, the VQB component incorporates any and/or all combinations of the aspects of the VQB discussed in the previous figures. As such, the VQB affects accessing, obtaining and the provision of information, services, transactions, and/or the like across various communications networks.

The VQB component may take user gesture inputs on displayed objects, and transform them via VQB components into search results display objects arranged by search relevance in proximity to the displayed objects, and/or the like and use of the VQB. In one embodiment, the VQB component 835 takes inputs (e.g., user actions 108, 1110, 113, 115, user input 211, and/or the like) etc., and transforms the inputs via various components (e.g., VQB 823a, IDOC 823b, UGC 823c, STG 823d, and/or the like), into outputs (e.g., objects refresh 114, objects moves to center of search results 116, search results 121a-f, 126a-f, 127a-f, 128a-f, 129a-f, 130a-f, 131a-f, 133a-h, 13a*-h*, search queries 213a-n, search results 214a-n, visual display 216, and/or the like), as shown in FIGS. 1-7, as well as throughout the specification.

The VQB component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the VQB server employs a cryptographic server to encrypt and decrypt communications. The VQB component may communicate to and/or with other components in a component collection, including itself, and/or facilities of the like. Most frequently, the VQB component communicates with the VQB database, operating systems, other program components, and/or the like. The VQB may contain, communicate, generate, obtain, and/or provide program component, system, user, and/or data communications, requests, and/or responses.

### Distributed VQBs

The structure and/or operation of any of the VQB node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques. For example, VQB server(s) and database(s) may all be localized within a single computing terminal. As another example, the VQB components may be localized within one or more entities (e.g., hospitals, pharmaceutical companies etc.) involved in coordinated patient management.

The configuration of the VQB controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

Non-limiting exemplary embodiments highlighting numerous further advantageous aspects include:

A1. A processor-implemented visual querying method embodiment, comprising:
obtaining an object-manipulating gesture input;
correlating the object-manipulating gesture input to a display object;
classifying via a processor the object-manipulating gesture input as a specified type of search request;
generating a search query according to the specified type of search request using metadata associated with the display object;
providing the search query;
obtaining, in response to providing the search query, search result display objects and associated search result display object relevance values; and
displaying the search result display objects arranged in proximity to the display object, wherein the search result display objects are arranged according to their associated search result display object relevance values.

A2. The method of embodiment A1, wherein the specified type of search request is a SELECT request.

A3. The method of embodiment A1, wherein the specified type of search request is a JOIN request.

A4. The method of embodiment A1, wherein the specified type of search request is a FILTER request.

A5. The method of embodiment A1, wherein one of the search result display objects having relevance value higher than another of the search result display objects is arranged closer to the display object.

A6. The method of embodiment A1, wherein the search result display objects are arranged in at least one concentric circles about a centroid of the display object.

A7. The method of embodiment A1, wherein the object-manipulating gesture input is obtained via a touch-sensitive input module.

A8. The method of embodiment A7, wherein the touch-sensitive input module is comprised within a touchscreen display system.

A9. The method of embodiment A1, further comprising:
obtaining a search replacement gesture input;
correlating the search replacement gesture input with one of the search result display objects;
generating a new search query using metadata associated with the search result display object correlated with the search replacement gesture input;
providing the new search query;
obtaining, in response to providing the new search query, new search result display objects; and
displaying the new search result display objects, wherein the new search result display objects are arranged in proximity to the search result display object correlated with the search replacement gesture input.

A10. The method of embodiment A9, further comprising:
maintaining a retraceable log of display objects for which search queries are generated.

A11 The method of embodiment A1, further comprising recognizing an archive gesture that stores the resulting search in an interactive search history.

A12. A visual querying system embodiment, comprising:

a processor; and

a memory disposed in communication with the processor and storing processor-executable instructions, the instructions comprising instructions to:
obtain an object-manipulating gesture input;
correlate the object-manipulating gesture input to a display object;
classify the object-manipulating gesture input as a specified type of search request;
generate a search query according to the specified type of search request using metadata associated with the display object;
provide the search query;
obtain, in response to providing the search query, search result display objects and associated search result display object relevance values; and
display the search result display objects arranged in proximity to the display object, wherein the search result display objects are arranged according to their associated search result display object relevance values.

A13. The system of embodiment A12, wherein the specified type of search request is a SELECT request.

A14. The system of embodiment A12, wherein the specified type of search request is a JOIN request.

A15. The system of embodiment A12, wherein the specified type of search request is a FILTER request.

A16. The system of embodiment A12, wherein one of the search result display objects having relevance value higher than another of the search result display objects is arranged closer to the display object.

A17. The system of embodiment A12, wherein the search result display objects are arranged in at least one concentric circles about a centroid of the display object.

A18. The system of embodiment A12, wherein the object-manipulating gesture input is obtained via a touch-sensitive input module.

A19. The system of embodiment A18, wherein the touch-sensitive input module is comprised within a touchscreen display system.

A20. The system of embodiment A12, the instructions further comprising instructions to:
obtain a search replacement gesture input;
correlate the search replacement gesture input with one of the search result display objects;
generate a new search query using metadata associated with the search result display object correlated with the search replacement gesture input;
provide the new search query;
obtain, in response to providing the new search query, new search result display objects; and
display the new search result display objects, wherein the new search result display objects are arranged in proximity to the search result display object correlated with the search replacement gesture input.

A21. The system of embodiment A20, the instructions further comprising instructions to:
maintain a retraceable log of display objects for which search queries are generated.

A22. The system of embodiment A12, the instructions further comprising instructions to recognize an archive gesture that stores the resulting search in an interactive search history.

A23. A processor-readable medium embodiment storing processor-executable visual querying instructions, the instructions comprising instructions to:
obtain an object-manipulating gesture input;
correlate the object-manipulating gesture input to a display object;
classify the object-manipulating gesture input as a specified type of search request;
generate a search query according to the specified type of search request using metadata associated with the display object;
provide the search query;
obtain, in response to providing the search query, search result display objects and associated search result display object relevance values; and
display the search result display objects arranged in proximity to the display object, wherein the search result display objects are arranged according to their associated search result display object relevance values.

A24. The medium of embodiment A23, wherein the specified type of search request is a SELECT request.

A25. The medium of embodiment A23, wherein the specified type of search request is a JOIN request.

A26. The medium of embodiment A23, wherein the specified type of search request is a FILTER request.

A27. The medium of embodiment A23, wherein one of the search result display objects having relevance value higher than another of the search result display objects is arranged closer to the display object.

A28. The medium of embodiment A23, wherein the search result display objects are arranged in at least one concentric circles about a centroid of the display object.

A29. The medium of embodiment A23, wherein the object-manipulating gesture input is obtained via a touch-sensitive input module.

A30. The medium of embodiment A29, wherein the touch-sensitive input module is comprised within a touchscreen display system.

A31. The medium of embodiment A23, the instructions further comprising instructions to:
obtain a search replacement gesture input;
correlate the search replacement gesture input with one of the search result display objects;
generate a new search query using metadata associated with the search result display object correlated with the search replacement gesture input;
provide the new search query;
obtain, in response to providing the new search query, new search result display objects; and
display the new search result display objects, wherein the new search result display objects are arranged in proximity to the search result display object correlated with the search replacement gesture input.

A32. The medium of embodiment A31, the instructions further comprising instructions to:
maintain a retraceable log of display objects for which search queries are generated.

A33. The medium of embodiment A23, the instructions further comprising instructions to recognize an archive gesture that stores the resulting search in an interactive search history.

B1. A processor-implemented visual query building method embodiment, comprising:
obtaining object-manipulating gesture inputs;
correlating the object-manipulating gesture inputs to a plurality of display objects;
classifying the object-manipulating gesture inputs as a conjoined-object search request gesture input;
generating a search query using conjoined metadata associated with the plurality of display objects, in response to classifying the object-manipulating gesture inputs as a conjoined-object search request gesture input, and providing the search query;
obtaining, in response to providing the search query:
   search result display objects; and
   search result display object relevance data indicating relevance of the search result display objects to each of the plurality of display objects; and
displaying the search result display objects arranged in proximity to the plurality of display objects;
wherein the proximity of each of the search result display objects to each of the plurality of display objects is based on the relevance of the search result display objects to each of the plurality of display objects.

B2. The method of embodiment B1, wherein the object-manipulating gesture inputs are obtained via a touch-sensitive input module.

B3. The method of embodiment B1, wherein one of the search result display objects having higher relevance value to one of the display objects is arranged closer to that display object than another of the search result display objects having lower relevance value to that display object.

B4. The method of embodiment B1, wherein the search result display objects are arranged in concentric circles about the centroids of the display objects.

B5. The method of embodiment B2, wherein the touch-sensitive input module is comprised within a touchscreen display system.

B6. The method of embodiment B1, wherein generating the search query further comprises:
identifying, for each of the plurality of display objects, a subset of the display object's metadata to utilize in generating the search query.

B7. The method of embodiment B1, further comprising:
maintaining a retraceable log of display objects for which search queries are generated.

B8. A visual query building system embodiment, comprising:

a processor; and

a memory disposed in communication with the processor and storing processor-executable instructions, the instructions comprising instructions to:
obtain object-manipulating gesture inputs;
correlate the object-manipulating gesture inputs to a plurality of display objects;
classify the object-manipulating gesture inputs as a conjoined-object search request gesture input;
generate a search query using conjoined metadata associated with the plurality of display objects, in response to classifying the object-manipulating gesture inputs as a conjoined-object search request gesture input, and provide the search query;
obtain, in response to providing the search query:
   search result display objects; and
   search result display object relevance data indicating relevance of the search result display objects to each of the plurality of display objects; and
display the search result display objects arranged in proximity to the plurality of display objects;
wherein the proximity of each of the search result display objects to each of the plurality of display objects is based on the relevance of the search result display objects to each of the plurality of display objects.

B9. The system of embodiment B8, wherein the object-manipulating gesture inputs are obtained via a touch-sensitive input module.

B10. The system of embodiment B8, wherein one of the search result display objects having higher relevance value to one of the display objects is arranged closer to that display object than another of the search result display objects having lower relevance value to that display object.

B11 The system of embodiment B8, wherein the search result display objects are arranged in concentric circles about the centroids of the display objects.

B12. The system of embodiment B9, wherein the touch-sensitive input module is comprised within a touchscreen display system.

B13. The system of embodiment B8, wherein generating the search query further comprises:
identifying, for each of the plurality of display objects, a subset of the display object's metadata to utilize in generating the search query.

B14. The system of embodiment B8, the instructions further comprising instructions to:
maintain a retraceable log of display objects for which search queries are generated.

B15. A processor-readable medium embodiment storing processor-executable visual query building instructions, the instructions comprising instructions to:
obtain object-manipulating gesture inputs;
correlate the object-manipulating gesture inputs to a plurality of display objects;
classify the object-manipulating gesture inputs as a conjoined-object search request gesture input;
generate a search query using conjoined metadata associated with the plurality of display objects, in response to classifying the object-manipulating gesture inputs as a conjoined-object search request gesture input, and provide the search query;
obtain, in response to providing the search query:
   search result display objects; and
   search result display object relevance data indicating relevance of the search result display objects to each of the plurality of display objects; and
display the search result display objects arranged in proximity to the plurality of display objects;
wherein the proximity of each of the search result display objects to each of the plurality of display objects is based on the relevance of the search result display objects to each of the plurality of display objects.

B16. The medium of embodiment B15, wherein the object-manipulating gesture inputs are obtained via a touch-sensitive input module.

B17. The medium of embodiment B15, wherein one of the search result display objects having higher relevance value to one of the display objects is arranged closer to that display object than another of the search result display objects having lower relevance value to that display object.

B18. The medium of embodiment B15, wherein the search result display objects are arranged in concentric circles about the centroids of the display objects.

B19. The medium of embodiment B16, wherein the touch-sensitive input module is comprised within a touchscreen display system.

B20. The medium of embodiment B15, wherein generating the search query further comprises:
identifying, for each of the plurality of display objects, a subset of the display object's metadata to utilize in generating the search query.

B21. The medium of embodiment B15, the instructions further comprising instructions to:
maintain a retraceable log of display objects for which search queries are generated.

In order to address various issues and improve over the prior art, the invention is directed to apparatuses, methods and systems for a mobile healthcare management system. The entirety of this application (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs of the VQB and/or characteristics of the hardware, software, network framework, monetization model and/or the like, various embodiments of the VQB may be implemented that enable a great deal of flexibility and customization. It is to be understood that, depending on the particular needs of the VQB and/or characteristics of the hardware, software, network framework, monetization model and/or the like, various embodiments of the VQB may be implemented that enable a great deal of flexibility and customization. The instant disclosure discusses example implementations of the VQB within the context of visually-driven general searching. However, it is to be understood that the system described herein can be readily configured for a wide range of other applications and/or implementations. For example, implementations of the VQB can be configured to operate within the context of financial services, inventory management, supply chain management, online shopping, travel agency services, office collaboration, online media sharing, and/or the like. Alternate implementations of the system may be utilized in various contexts outside touchscreen LCDs and/or smartphones, including, but not limited to: desktop computers, tablet computers, gaming consoles, financial trading devices, home/office appliances (e.g., scanners, fax machines, all-in-one office machines, local network search appliances), and/or the like. It is to be understood that the VQB may be further adapted to various other implementations.

What is claimed is:

1. A processor-implemented visual querying method, comprising:
obtaining an object-manipulating gesture input;
correlating the object-manipulating gesture input to a display object;
classifying via a processor the object-manipulating gesture input as a specified type of search request;
generating a search query according to the specified type of search request using metadata associated with the display object;
providing the search query;
obtaining, in response to providing the search query, search result display objects and associated search result display object relevance values; and
displaying the search result display objects arranged in proximity to the display object, wherein the search result display objects are arranged according to their associated search result display object relevance values.

2. The method of claim 1, wherein the specified type of search request is a SELECT request.

3. The method of claim 1, wherein the specified type of search request is a JOIN request.

4. The method of claim 1, wherein the specified type of search request is a FILTER request.

5. The method of claim 1, wherein one of the search result display objects having relevance value higher than another of the search result display objects is arranged closer to the display object.

6. The method of claim 1, wherein the search result display objects are arranged in at least one concentric circles about a centroid of the display object.

7. The method of claim 1, wherein the object-manipulating gesture input is obtained via a touch-sensitive input module.

8. The method of claim 7, wherein the touch-sensitive input module is comprised within a touchscreen display system.

9. The method of claim 1, further comprising:
obtaining a search replacement gesture input;
correlating the search replacement gesture input with one of the search result display objects;
generating a new search query using metadata associated with the search result display object correlated with the search replacement gesture input;
providing the new search query;
obtaining, in response to providing the new search query, new search result display objects; and
displaying the new search result display objects, wherein the new search result display objects are arranged in proximity to the search result display object correlated with the search replacement gesture input.

10. The method of claim 9, further comprising:
maintaining a retraceable log of display objects for which search queries are generated.

11. The method of claim 1, further comprising recognizing an archive gesture that stores the resulting search in an interactive search history.

12. A visual querying system, comprising:
a processor; and
a memory disposed in communication with the processor and storing processor-executable instructions, the instructions comprising instructions to:
obtain an object-manipulating gesture input;
correlate the object-manipulating gesture input to a display object;
classify the object-manipulating gesture input as a specified type of search request;
generate a search query according to the specified type of search request using metadata associated with the display object;
provide the search query;
obtain, in response to providing the search query, search result display objects and associated search result display object relevance values; and
display the search result display objects arranged in proximity to the display object, wherein the search result display objects are arranged according to their associated search result display object relevance values.

13. The system of claim 12, wherein the specified type of search request is a SELECT request.

14. The system of claim 12, wherein the specified type of search request is a JOIN request.

15. The system of claim 12, wherein the specified type of search request is a FILTER request.

16. The system of claim 12, wherein one of the search result display objects having relevance value higher than another of the search result display objects is arranged closer to the display object.

17. The system of claim 12, wherein the search result display objects are arranged in at least one concentric circles about a centroid of the display object.

18. The system of claim 12, wherein the object-manipulating gesture input is obtained via a touch-sensitive input module.

19. The system of claim 18, wherein the touch-sensitive input module is comprised within a touchscreen display system.

20. The system of claim 12, the instructions further comprising instructions to:
obtain a search replacement gesture input;
correlate the search replacement gesture input with one of the search result display objects;
generate a new search query using metadata associated with the search result display object correlated with the search replacement gesture input;
provide the new search query;
obtain, in response to providing the new search query, new search result display objects; and
display the new search result display objects, wherein the new search result display objects are arranged in proximity to the search result display object correlated with the search replacement gesture input.

21. The system of claim 20, the instructions further comprising instructions to:
maintain a retraceable log of display objects for which search queries are generated.

22. The system of claim 12, the instructions further comprising instructions to recognize an archive gesture that stores the resulting search in an interactive search history.

23. A processor-readable medium storing processor-executable visual querying instructions, the instructions comprising instructions to:
obtain an object-manipulating gesture input;
correlate the object-manipulating gesture input to a display object;
classify the object-manipulating gesture input as a specified type of search request;
generate a search query according to the specified type of search request using metadata associated with the display object;
provide the search query;
obtain, in response to providing the search query, search result display objects and associated search result display object relevance values; and
display the search result display objects arranged in proximity to the display object, wherein the search result display objects are arranged according to their associated search result display object relevance values.

24. The medium of claim 23, wherein the specified type of search request is a SELECT request.

25. The medium of claim 23, wherein the specified type of search request is a JOIN request.

26. The medium of claim 23, wherein the specified type of search request is a FILTER request.

27. The medium of claim 23, wherein one of the search result display objects having relevance value higher than another of the search result display objects is arranged closer to the display object.

28. The medium of claim 23, wherein the search result display objects are arranged in at least one concentric circles about a centroid of the display object.

29. The medium of claim 23, wherein the object-manipulating gesture input is obtained via a touch-sensitive input module.

30. The medium of claim 29, wherein the touch-sensitive input module is comprised within a touchscreen display system.

31. The medium of claim 23, the instructions further comprising instructions to:
obtain a search replacement gesture input;
correlate the search replacement gesture input with one of the search result display objects;
generate a new search query using metadata associated with the search result display object correlated with the search replacement gesture input;
provide the new search query;
obtain, in response to providing the new search query, new search result display objects; and
display the new search result display objects, wherein the new search result display objects are arranged in proximity to the search result display object correlated with the search replacement gesture input.

32. The medium of claim 31, the instructions further comprising instructions to:
maintain a retraceable log of display objects for which search queries are generated.

33. The medium of claim 23, the instructions further comprising instructions to recognize an archive gesture that stores the resulting search in an interactive search history.
